(19) United States
(12) Patent Application Publication
(10) Pub. No.: US 2014/0146740 A1
(43) Pub. Date: May 29, 2014

(54) PRIORITY CONTROL METHOD, SERVER, AND STORAGE MEDIUM

(71) Applicant: FUJITSU LIMITED, Kawasaki-shi (JP)

(72) Inventors: Takafumi Yamashina, Hadano (JP); Hirokazu Tateishi, Kawasaki (JP); HIDEKI IWAMURA, Sagamihara (JP); Junichi Nishi, Yokohama (JP); Kazunori Kirita, Kawasaki (JP); Shigehisa Ono, Kawasaki (JP); Yasuhiro SETA, Sagamihara (JP); Toshiaki Imai, Sagamihara (JP)

(73) Assignee: FUJITSU LIMITED, Kawasaki-shi (JP)

(21) Appl. No.: 14/068,299

(22) Filed: Oct. 31, 2013

(30) Foreign Application Priority Data
Nov. 29, 2012 (JP) 2012-261107

(51) Int. Cl. H04W 72/10

(52) U.S. Cl. CPC H04W 72/10
USPC 370/315

(57) ABSTRACT

A priority control method for use in a server includes upon receiving a priority control request related to communication between a first terminal device connected to a first wireless network and a second terminal device connected to a second wireless network, determining a priority for the communication, and performing by the server, a settings on a first wireless base station in the first wireless network to which the first terminal device is connected, a setting on a second wireless base station in the second wireless network to which the second terminal device is connected, and a setting on at least one relaying apparatus that relays communication in a communication path between the first wireless base station and the second wireless base station, thereby communication between the first terminal device and the second terminal device is relayed with the determined priority.

### CROSS-REFERENCE TO RELATED APPLICATIONS

This application is based upon and claims the benefit of priority from the prior Japanese Patent Application No. 2012-261107 filed on Nov. 29, 2012, the entire contents of which are incorporated herein by reference.

### FIELD

The embodiments discussed herein are related to a priority control method, a server, and a storage medium.

### BACKGROUND

With the advent of information and communication technology, terminal devices have become more sophisticated. For example, smartphones (one type of cell phone) can be used as sophisticated information and communication terminals. With a widespread use of such sophisticated terminal devices, an amount of information communicated via a network has been increasing. As a result, it is difficult to communicate all of communication packets at high speed.

Accordingly, a technology for setting a priority for a packet to be communicated and preferentially communicating an important packet has been developed. The value of priority may be set by using, for example, a differentiated services code point (DSCP) value. For example, the priority of a packet used for phone call, such as a packet for Voice over Internet Protocol (VoIP), may be increased. In contrast, the priority of a packet used for browsing a web page may be decreased. In this manner, interruption of sound during voice communication in VoIP can be reduced.

In addition, a technology for controlling a priority for each of users has been developed. For example, a session QoS control apparatus has been developed. In user session communication in which Quality of Service (QoS) policy can be set, the session QoS control apparatus analyzes a QoS request for each of user sessions and automatically sets a QoS policy for a network node.

However, if a communication path between two terminal devices that communicate with each other includes a wired communication zone and a wireless communication zone, it is difficult to maintain the communication quality for both wired communication and wireless communication. Accordingly, for example, even when high-speed communication is available using a high priority in a wired communication zone, a high-speed communication is unavailable for the entire communication path if the communication speed is low in a wireless communication zone.

Japanese Laid-open Patent Publication No. 2005-151533 discusses such technologies.

### SUMMARY

According to an aspect of the embodiments, a priority control method for use in a server includes upon receiving a priority control request related to communication between a first terminal device connected to a first wireless network and a second terminal device connected to a second wireless network, determining a priority for the communication, and controlling the communicating between the first terminal devise and the second terminal device for relaying according to the determined priority by performing by the server, a settings on a first wireless base station in the first wireless network to which the first terminal device is connected, a setting on a second wireless base station in the second wireless network to which the second terminal device is connected, and a setting on at least one relaying apparatus that relays communication in a communication path between the first wireless base station and the second wireless base station, thereby communication between the first terminal device and the second terminal device is relayed with the determined priority.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of the functional configuration of apparatuses according to a first exemplary embodiment;

FIG. 2 illustrates an example of the system configuration according to a second exemplary embodiment;

FIG. 3 illustrates an example of the hardware configuration of a policy server according to the second exemplary embodiment;

FIG. 4 illustrates an example of the hardware configuration of a router according to the second exemplary embodiment;

FIG. 5 illustrates an example of the hardware configuration of a wireless AP according to the second exemplary embodiment;

FIG. 6 illustrates an example of the hardware configuration of a terminal device according to the second exemplary embodiment;

FIG. 7 is a schematic illustration of priority control according to the second exemplary embodiment;

FIG. 8 is a block diagram of the function of each of apparatuses according to the second exemplary embodiment;

FIG. 9 illustrates an example of the data structure of a user agreement information management DB;

FIG. 10 illustrates an example of the data structure of a priority control information management DB;

FIG. 11 illustrates an example of the data structure of a management data storage unit of a terminal device serving as a connection source;

FIG. 12 illustrates an example of the data structure of a management data storage unit of a terminal device serving as a connection destination;

FIG. 13 illustrates an example of the data structure of a management data storage unit of a router;

FIG. 14 illustrated an example of the data structure of a management data storage unit of the wireless AP;

FIG. 15 is a sequence diagram illustrating a first half of a communication procedure with priority control;

FIG. 16 is a sequence diagram of a second half of the communication procedure with priority control;

FIG. 17 is a flowchart illustrating an example of the procedure of processing performed by a policy server;

FIG. 18 is a flowchart illustrating an example of the procedure of processing performed by a router;

FIG. 19 is a flowchart illustrating an example of the procedure of processing performed by a wireless AP;

FIG. 20 is a flowchart illustrating an example of the procedure of processing performed by a terminal device serving as a connection destination;

FIG. 21 illustrates an example of the parameters for each of the ACs in EDCA;

FIG. 22 illustrates an assignment relationship between a DSCP value and an AC;

FIG. 23 illustrates an example of the priority control of a packet sent from a terminal device serving as a connection source;

FIG. 24 illustrates an example of the priority control of a packet received by a terminal device serving as a connection source;

FIG. 25 illustrates an example of mapping of a value indicating a priority; and

FIG. 26 illustrates a priority mapping process in detail.

### DESCRIPTION OF EMBODIMENTS

Exemplary embodiments are described below with reference to the accompanying drawings. It is to be understood that some or all of the exemplary embodiments may be combined if no conflict exists.

### First Exemplary Embodiment

A first exemplary embodiment is described first. According to the first exemplary embodiment, in communication through a wired network and a wireless network, the same communication quality (e.g., the communication speed) can be applied to the wired network and the wireless network. That is, even in communication through a wired network and a wireless network, important communication can have a consistent communication quality from a source device to a destination device. Thus, a situation in which although high-quality communication can be performed in part of a network, the communication quality of the other network is low decreases the quality of the entire network does not occur.

For example, at a public wireless access point (a wireless AP), users who access the wireless AP have equal communication rate constraints, as a general rule. Accordingly, if the capacity of the network communication at the wireless AP exceeds its limit, all of the users who access the wireless AP are unable to perform communication or experience communication delay. In addition, in a wireless communication network, bandwidth control is not performed. Accordingly, if some heavy users perform large amount of data communication, the other users who access the same wireless AP have deteriorated service quality.

Note that even in a wireless network, the priority of particular communication can be increased. However, in most cases, a terminal device connected to a wireless network communicates with another terminal device connected via a wired network which is connected to the wireless network. In such a case, the priority in the wired network is still low. Therefore, even when the priority in the wireless network is increased, the quality of communication between the terminal devices is not increased. This also applies to the case in which the priority in the wired network is increased when the priority in the wireless network is still low. Accordingly, in the first exemplary embodiment, priority control is performed so that the same quality control policies can be maintained throughout the communication path between two terminal devices that communicate with each other.

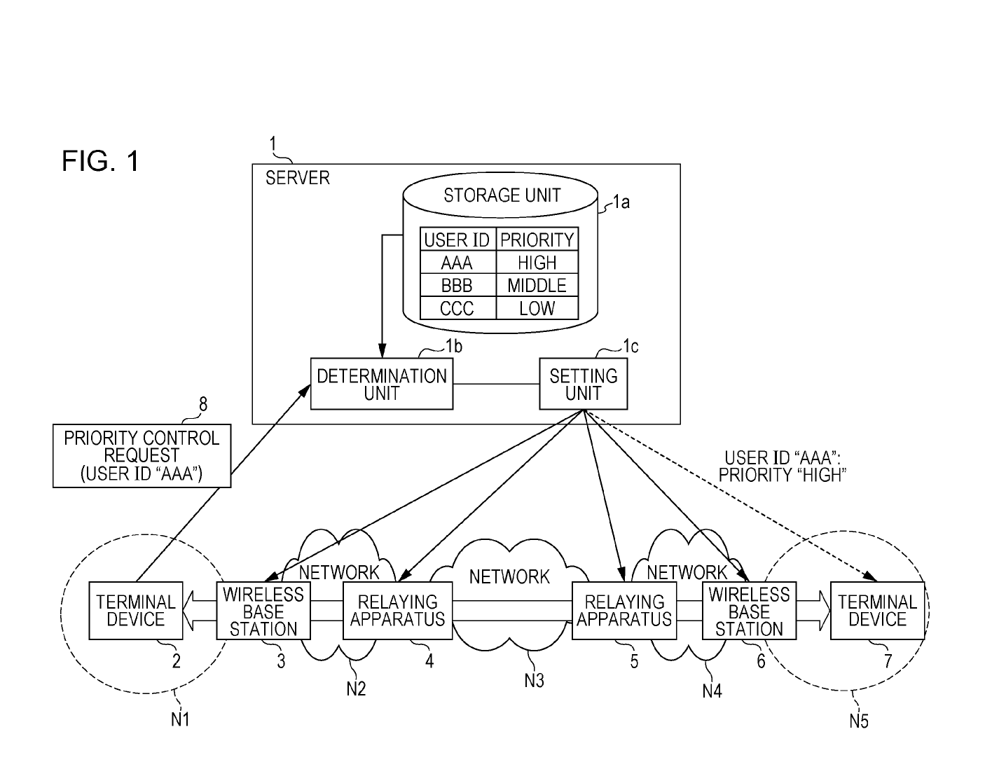

FIG. 1 illustrates an example of the functional configuration of apparatuses according to the first exemplary embodiment. A server 1 performs priority control on a plurality of networks N1, N2, N3, N4, and N5. The networks N1 and N5 are wireless networks, and the networks N2, N3, and N4 are wired networks. A terminal device 2 in the network N1 can be wirelessly connected to a wireless base station 3. A terminal device 7 in the network N5 can be wirelessly connected to a wireless base station 6. The wireless base station 3 and a relaying apparatus 4 are connected to the network N2. The relaying apparatus 4 and a relaying apparatus 5 are connected to the network N3. The relaying apparatus 5 and the wireless base station 6 are connected to the network N4.

In such a network system, when the terminal device 2 communicates with the terminal device 7, the communication is performed via the plurality of networks N1, N2, N3, N4, and N5. Priority communication control can be performed in each of the networks N1, N2, N3, N4, and N5. For example, a packet transmitted in the networks N1, N2, N3, N4, and N5 has been transmitted with a priority set by an entry device of the networks. However, if, during the communication between the terminal device 2 and the terminal device 7, different priorities are set for the packet in the networks N1, N2, N3, N4, and N5, the network having the low priority become a bottleneck and, therefore, it is difficult to provide communication having desired quality. Thus, according to the first exemplary embodiment, the server 1 that performs priority control is provided.

To perform priority control, the server 1 includes a storage unit 1a, a determination unit 1b, and a setting unit 1c.

The storage unit 1a stores a priority in association with, for example, a user ID. For example, in the storage unit 1a, a priority in accordance with the service level of a priority control agreement is stored in association with the user ID of a user who has signed the agreement.

Upon receiving a priority control request 8 related to communication between the terminal device 2 connected to the wireless network N1 and the terminal device 7 connected to the wireless network N5, the determination unit 1b determines the priority of communication. The priority control request 8 is output from, for example, the terminal device 2. In this case, the priority control request 8 contains the user ID of a user who operates the terminal device 2. The determination unit 1b refers to, for example, the information in the storage unit 1a and sets a priority of communication between the terminal device 2 and the terminal device 7 to the priority corresponding to the user ID contained in the priority control request 8.

The setting unit 1c sets the priority so that the wireless base station 3 having the terminal device 2 connected thereto, the wireless base station 6 having the terminal device 7 connected thereto, and the relaying apparatuses 4 and 5 relay communication data from the terminal device 2 to the terminal device 7 on the basis of the priority determined by the determination unit 1b. For example, the setting unit 1c sends a pair comprising of the user ID contained in the priority control request 8 and the determined priority to the wireless base station 3, the wireless base station 6, and the relaying apparatuses 4 and 5. In addition, the setting unit 1c can perform setting on the terminal device 2 and the terminal device 7 so that the terminal device 2 and the terminal device 7 can send data using the priority determined by the determination unit 1b.

When the terminal device 2 serves as a connection source and if the terminal device 7 serves as a connection destination in communication, the terminal device 2 sends the priority control request 8 to the server 1 first. The priority control request 8 contains, for example, the identifiers of the connection source and the connection destination and the user ID of the user who operates the terminal device 2.

Upon receiving the priority control request 8, the determination unit 1b of the server 1 determines the priority. In the example illustrated in FIG. 1, since the priority control request 8 contains a user ID of “AAA”, the determination unit 1b refers to the information in the storage unit 1a and acquires the priority “High” corresponding to the user ID “AAA”. Thereafter, the determination unit 1b sets the priority of communication between the terminal device 2 and the terminal device 7 to the acquired priority.

Subsequently, the setting unit 1c performs the setting for the wireless base stations 3 and 6 and the relaying apparatuses 4 and 5 so that the communication between the terminal devices 2 and 7 is performed on the basis of the determined priority. For example, the setting unit 1c sends a pair consisting of the user ID and the priority to the wireless base stations 3 and 6 and the relaying apparatuses 4 and 5. In the example illustrated in FIG. 1, a pair consisting of the user ID “AAA” and the priority “High” is sent.

The wireless base stations 3 and 6 and the relaying apparatuses 4 and 5 relay communication data from the terminal device 2 to the terminal device 7 on the basis of the set priority. For example, when the terminal device 2 transmits data to the terminal device 7, the terminal device 2 transmits a packet destined for the terminal device 7 and including the user ID “AAA” to the wireless base station 3 with a quality of “High” in accordance with the agreement signed by the user of the terminal device 2. The wireless base station 3 forwards the received packet to the relaying apparatus 4 via the network N2 with a quality corresponding to the priority “High” for the user ID “AAA”. The wireless base station 4 forwards the received packet to the relaying apparatus 5 via the network N3 with a quality corresponding to the priority “High” for the user ID “AAA”. The relaying apparatus 5 forwards the received packet to the wireless base station 6 via the network N4 with a quality corresponding to the priority “High” for the user ID “AAA”. The wireless base station 6 forwards the received packet to the terminal device 7 via the network N5 with a quality corresponding to the priority “High” for the user ID “AAA”. In this manner, data transmission from the terminal device 2 to the terminal device 7 can be performed using the same quality control policies.

Data transmission from the terminal device 7 to the terminal device 2 (in the opposite direction) is described next. Note that like the above-described example, in this example, a pair consisting of the user ID “AAA” and the priority “High” is transmitted from the server 1 to the terminal device 7 in advance. For example, the terminal device 7 transmits data in response to a data acquisition request packet including the user ID “AAA” from the terminal device 2. In this case, the terminal device 7 transmits a packet including data to the wireless base station 6 with a quality corresponding to the priority “High” for the user ID “AAA” indicated by the data acquisition request packet. At that time, the terminal device 7 sets, in the packet to be transmitted, the user ID “AAA” of the user who operates the terminal device 2. Thus, the packet is transmitted to the terminal device 2 via the wireless base station 6, the relaying apparatus 5, the relaying apparatus 4, and the wireless base station 3 with a quality corresponding to the priority “High” for the user ID “AAA”. In this manner, data transmission from the terminal device 7 to the terminal device 2 can be performed using the same quality control policies.

As described above, according to the first exemplary embodiment, even when data is communicated via a wired network and a wireless network, communication between terminal devices can be performed using the same quality control policies. As a result, high-quality data communication can be ensured for a user who paid a fee on the basis of an agreement at all times.

Note that the quality of communication is defined by the bandwidth used for the data communication. That is, when high-quality communication is performed, the communication is performed using a wide bandwidth. In contrast, when low-quality communication is performed, the communication is performed using a bandwidth narrower than the bandwidth for the high-quality communication. Alternatively, a wait time during data communication may be changed in accordance with the quality of communication. In such a case, if high-quality communication is performed, data communication is performed with a short wait time. In contrast, if low-quality communication is performed, data communication is performed with a wait time that is longer than that in the high-quality communication.

Note that the determination unit 1b and the setting unit 1c can be realized by a processer included in, for example, the server 1. In addition, the storage unit 1a can be realized by a random access memory (RAM) included in, for example, the server 1.

Note that the lines between the components illustrated in FIG. 1 represent part of the communication path. A communication path other than the illustrated communication path can be set.

### Second Exemplary Embodiment

A second exemplary embodiment is described next. In the second exemplary embodiment, priority control is performed for communication using a session initiation protocol (SIP). Note that according to the second exemplary embodiment, the priority control in a wired network is performed using DSCP. In addition, for example, a wireless network is a Wireless Fidelity (Wi-Fi) network, and the priority control in the wireless network is performed using Wi-Fi Multimedia (WMM).

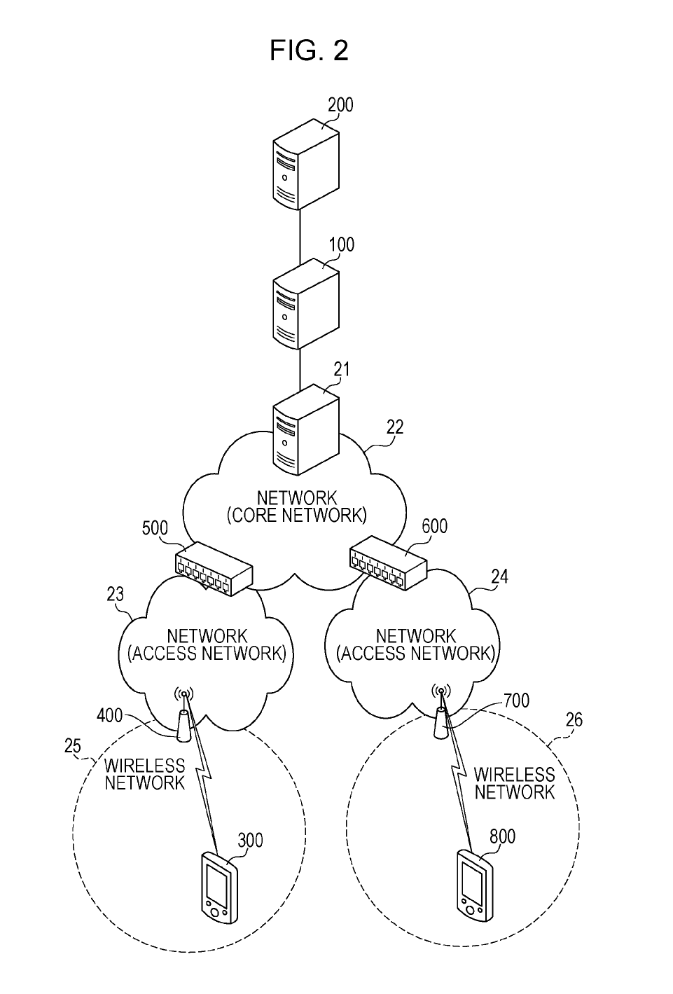

FIG. 2 illustrates an example of the system configuration according to the second exemplary embodiment. According to the second exemplary embodiment, a policy server 100 manages the priority of communication for each of users. Each time the policy server 100 receives a priority control request from a terminal device operated by a user, the policy server 100 sends, to all of communication apparatuses in the transmission path of the communication, a priority control instruction for the communication established for the terminal device serving as a caller. A database server 200 is connected to the policy server 100. The database server 200 stores information regarding the service level of the agreement signed by a user and the current status of the priority control.

In addition, the policy server 100 is connected to a SIP server 21. The SIP server 21 associates a telephone number with an Internet Protocol (IP) address using SIP, and establishes IP telephone communication between a terminal device 300 and a terminal device 800.

Routers 500 and 600 are connected to the SIP server 21 via a network 22. The network 22 is a wired network. For example, the network 22 is a core network for high capacity communication. Note that while FIG. 2 illustrates only two routers 500 and 600, a plurality of routers that are not illustrated in FIG. 2 are also present in the network 22, in reality. The routers in the network 22 relay a packet. Each of the routers determines the destination of a received packet and, thereafter, forwards the packet to an appropriate path in accordance with the destination. In this manner, a packet in the network 22 is transmitted to the destination.

Wireless access points (APs) 400 and 700 are connected to the routers 500 and 600 via the networks 23 and 24, respectively. For example, the networks 23 and 24 are access networks for connecting terminal devices located in different areas to the network 22 serving as a core network. Note that like the router 500 or 600, a router that relays data between an access network and a core network is referred to as an “edge router”.

Each of the wireless APs 400 and 700 incorporates a data connect adapter. The data connect adapter acts as a device that establishes a SIP session of a communication terminal. The wireless APs 400 and 700 communicate with terminal devices in wireless communication networks (the wireless network 25 and 26), respectively. In the example illustrated in FIG. 2, the terminal device 300 is located in the wireless network 25 of the wireless AP 400, and the terminal device 800 is located in the wireless network 26 of the wireless AP 700.

Note that the policy server 100 is an example of the server 1 according to the first exemplary embodiment illustrated in FIG. 1. The terminal devices 300 and 800 are examples of the terminal devices 2 and 7 according to the first exemplary embodiment illustrated in FIG. 1, respectively. The wireless APs 400 and 700 are examples of the wireless base stations 3 and 6 according to the first exemplary embodiment illustrated in FIG. 1, respectively. The routers 500 and 600 are examples of the relaying apparatuses 4 and 5 according to the first exemplary embodiment illustrated in FIG. 1, respectively.

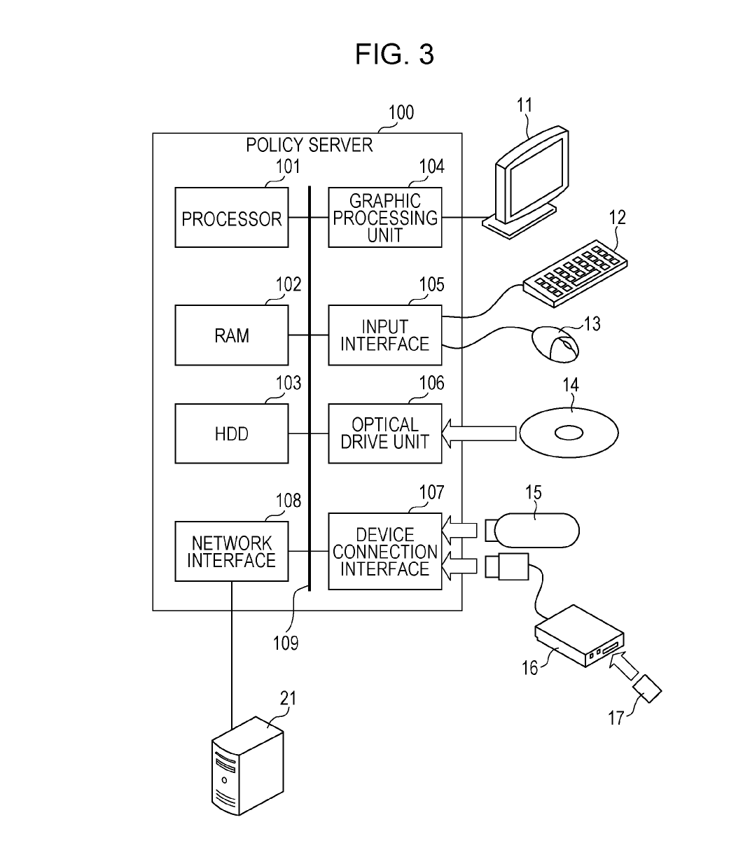

FIG. 3 illustrates an example of the hardware configuration of a policy server according to the second exemplary embodiment. The policy server 100 is entirely controlled by a processor 101. The processor 101 has a random access memory (RAM) 102 and a plurality of peripheral devices connected thereto via a bus 109.

The RAM 102 is used as a main memory unit of the policy server 100. The RAM 102 temporarily stores at least part of an operating system (OS) and an application program to be executed by the processor 101. In addition, a variety of data used for processing performed by the processor 101 are stored in the RAM 102.

Examples of the peripheral devices connected to the bus 109 include a hard disk drive (HDD) 103, a graphic processing unit 104, an input interface 105, an optical drive unit 106, a device connection interface 107, and a network interface 108.

The HDD 103 magnetically reads and writes data from and to an incorporated disk. The HDD 103 is used as an auxiliary storage unit of the policy server 100. The HDD 103 stores the program of the OS, an application program, and a variety of data. Note that a semiconductor memory, such as a flash memory, can be also used as an auxiliary storage unit.

The graphic processing unit 104 has a monitor 11 connected thereto. In response to an instruction received from the processor 101, the graphic processing unit 104 displays an image in a screen of the monitor 11. Examples of the monitor 11 include a display unit using a cathode ray tube (CRT) and liquid crystal display unit.

The input interface 105 has a keyboard 12 and a mouse 13 connected thereto. The input interface 105 transmits signals received from the keyboard 12 and the mouse 13 to the processor 101. Note that the mouse 13 is an example of a pointing device. Another type of a pointing device may be employed. Example of the pointing device of another type include a touch panel, a tablet, a touch pad, and a trackball.

The optical drive unit 106 reads data recorded in an optical disk 14 using, for example, a laser beam. The optical disk 14 is a portable recording medium having data recorded therein so that the data is readable by reflection of a light beam. Examples of the optical disk 14 include a digital versatile disc (DVD), a DVD-RAM, a compact disc read only memory (CD-ROM), a CD-R (readable), and a CD-RW (rewritable).

The device connection interface 107 is a communication interface that allows a peripheral device to be connected to the policy server 100. For example, a memory unit 15 and a memory reader/writer 16 may be connected to the device connection interface 107. The memory unit 15 is a recording medium having a function for communicating with the device connection interface 107. The memory reader/writer 16 is a unit for writing data into a memory card 17 or reading data from the memory card 17. The memory card 17 is a recording medium of a card type.

The network interface 108 is connected to the SIP server 21. The network interface 108 communicates data in the SIP server 21. In addition, the network interface 108 receives and transmits data from and to the routers 500 and 600, the wireless APs 400 and 700, and the terminal devices 300 and 800 via the SIP server 21.

Note that the server 1 according to the first exemplary embodiment illustrated in FIG. 1 can be configured using the hardware that is similar to that of the policy server 100.

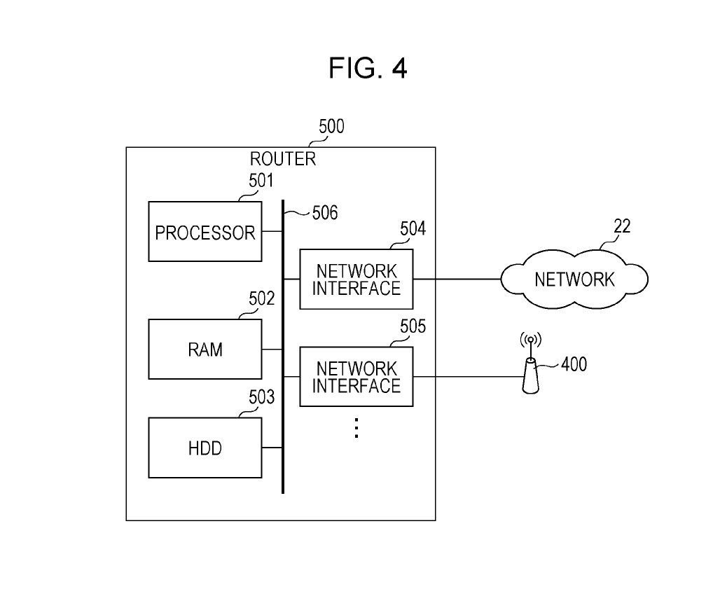

FIG. 4 illustrates an example of the hardware configuration of a router according to the second exemplary embodiment. A router 500 includes a processor 501, a RAM 502, an HDD 503, and a plurality of network interfaces 504, 505, . . . . The processor 501, the RAM 502, the HDD 503, and the network interfaces 504, 505, . . . are connected with one another via a bus 506. The processor 501 performs overall control of the router 500. The RAM 502 stores a program to be executed by the processor 501 and data used for processing performed by the processor 501. The HDD 503 stores an OS of the router 500, a program, and a variety of data. The network interface 504 is connected to the network 22 and performs communication via the network 22. The network interface 505 is connected to the wireless AP 400 and performs communication with the terminal device 300 via the wireless AP 400.

Note that each of the SIP server 21 and the router 600 can be configured using the hardware that is similar to that of the router 500 illustrated in FIG. 4. In addition, each of the relaying apparatus 4 and 5 according to the first exemplary embodiment illustrated in FIG. 1 can be also configured using the hardware that is similar to that of the router 500.

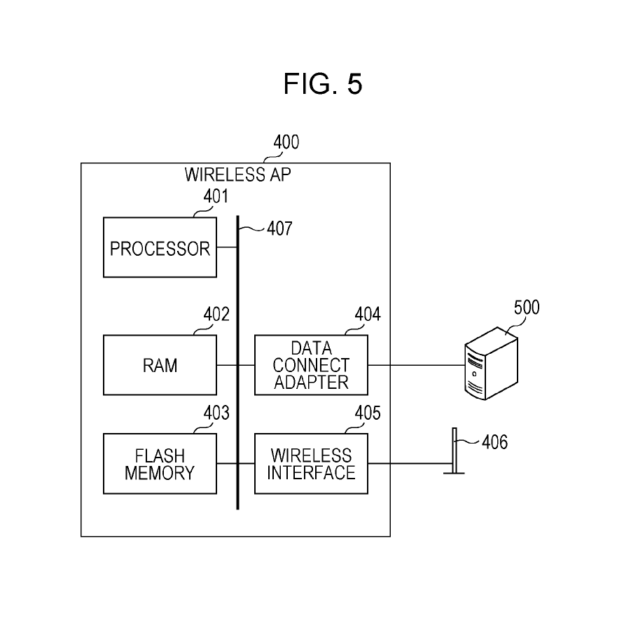

FIG. 5 illustrates an example of the hardware configuration of a wireless AP according to the second exemplary embodiment. The wireless AP 400 includes a processor 401, a RAM 402, a flash memory 403, a data connect adapter 404, and a wireless interface 405. The processor 401, the RAM 402, the flash memory 403, the data connect adapter 404, and the wireless interface 405 are connected to one another via a bus 407. The processor 401 performs overall control of the wireless AP 400. The RAM 402 stores a program to be executed by the processor 401 and data used for the processing performed by the processor 401. The flash memory 403 stores the OS of the wireless AP 400, a program, and a variety of data. The data connect adapter 404 is connected to the router 500 and performs communication via the router 500. In addition, the data connect adapter 404 communicates with the SIP server 21 and establish SIP communication with a terminal device. The wireless interface 405 has an antenna 406 connected thereto. The wireless interface 405 performs wireless communication via the antenna 406 to wirelessly communicate with a terminal device located within the communication area.

Note that the wireless AP 700 can be configured using the hardware that is similar to that of the wireless AP 400 illustrated in FIG. 5. In addition, each of the wireless base stations 3 and 6 according to the first exemplary embodiment illustrated in FIG. 1 can be also configured using the hardware that is similar to that of the wireless AP 400.

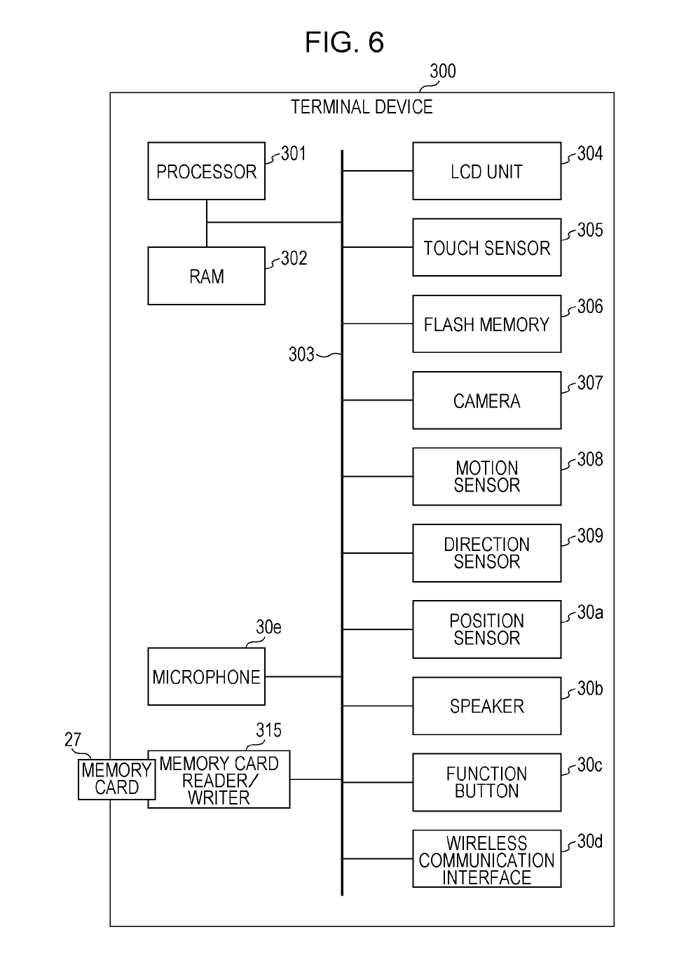

FIG. 6 illustrates an example of the hardware configuration of a terminal device according to the second exemplary embodiment. The terminal device 300 is entirely controlled by a processor 301. The processor 301 has a RAM 302 and a plurality of peripheral devices connected thereto via a bus 303.

The RAM 302 is used as a main memory unit of the terminal device 300. The RAM 302 temporarily stores at least part of an operating system (OS) and an application program to be executed by the processor 301. In addition, a variety of data used for processing performed by the processor 301 are stored in the RAM 302.

Examples of the peripheral devices connected to the bus 303 include a liquid crystal display (LCD) unit 304 and a touch sensor 305. The bus 303 has a flash memory 306, a camera 307, a motion sensor 308, a direction sensor 309, a position sensor 30a, a speaker 30b, a function button 30c, a wireless communication interface 30d, a microphone 30e, and a memory card reader/writer 315 each connected thereto.

The flash memory 306 is one type of nonvolatile memory element. For example, the flash memory 306 stores software, such as the OS, a driver, and an application. The camera 307 converts an image incident through a lens into an electric signal using an image sensing device, such as a charge coupled device image sensor (CCD). The motion sensor 308 detects acceleration in three-dimensional space. The direction sensor 309 detects the orientation of the terminal device 300 (the direction). The position sensor 30a receives, for example, a signal emitted from an artificial satellite of Global Positioning System (GPS) and detects the position of the terminal device 300. The speaker 30b converts an electric signal sent from the processor 301 into sound waves and outputs the sound waves. The function button 30c is a hardware button, such as a power button. The wireless communication interface 30d performs wireless phone call and wireless communication. For example, the wireless communication interface 30d can perform communication through a third-generation mobile communication system, Wi-Fi communication, or Long Term Evolution (LTE) communication. The microphone 30e converts sound waves into an audio signal. At that time, the microphone 30e converts the audio signal from an analog form to a digital form and sends the digital signal to the processor 301.

The memory card reader/writer 315 writes data to a memory card 27 or reads data from the memory card 27. The memory card reader/writer 315 allows the memory card 27 to be removable inserted thereinto.

Note that the terminal device 800 can be configured using the hardware that is similar to that of the terminal device 300 illustrated in FIG. 6. In addition, each of the terminal devices 2 and 7 according to the first exemplary embodiment illustrated in FIG. 1 can be also configured using the hardware that is similar to that of the terminal device 300.

By using the above-described hardware, the second exemplary embodiment can be achieved. Note that the processors 101, 301, 401, and 501 may be configured as a multiprocessor. Each of the processors 101, 301, 401, and 501 is one of, for example, a central processing unit (CPU), a microprocessing unit (MPU), and a digital signal processor (DSP). At least some of the functions of the processors 101, 301, 401, and 501 may be realized by an electronic circuit, such as an application specific integrated circuit (ASIC) or a programmable logic device (PLD).

By executing a program recorded in, for example, a computer-readable recording medium, the policy server 100, the routers 500 and 600, the wireless APs 400 and 700, and the terminal devices 300 and 800 can realize the process functions according to the second exemplary embodiment. The program that defines the process executed by each of the units can be stored in a variety of recording media. For example, the program to be executed by each of the units can be stored in an HDD or a flash memory. The processor of each of the units loads at least part of the program stored in the HDD or the flash memory into the RAM and, thereafter, executes the program. Alternatively, the program to be executed by each of the units may be stored in a portable recording medium, such as the optical disk 14, the memory unit 15, or the memory card 17 or 27. The program stored in such a portable recording medium is installed in the HDD under the control of the processor and, thus, becomes executable. Alternatively, the processor can directly read the program from the portable recording medium and execute the program.

The priority control according to the second exemplary embodiment is briefly described below.

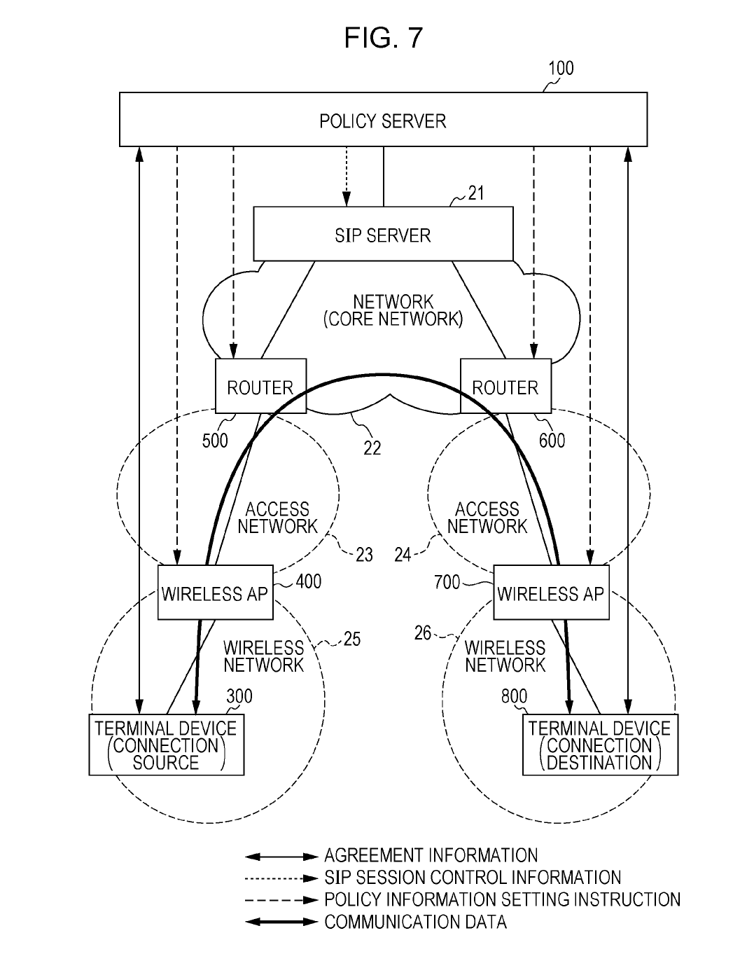

FIG. 7 is a schematic illustration of the priority control according to the second exemplary embodiment. The policy server 100 exchanges agreement information with each of the terminal devices 300 and 800. For example, the policy server 100 receives the user ID of a user who operates the terminal device 300 (a caller ID) from the terminal device 300 serving as a connection source (a caller terminal) and identifies a pre-registered service level in the agreement. The policy server 100 sends a message indicating, for example, the priority of communication in accordance with the identified service level of the agreement to both the terminal devices 300 and 800. Note that at that time, the terminal device 300 serves as a connection source, and the terminal device 800 serves a connection destination (a called terminal). Thus, the terminal devices 300 and 800 can send a packet to their own wireless networks 25 and 26 at speeds corresponding to the received priority, respectively. Note that if the priority corresponding to the service level in the agreement applied to the terminal device 300 is preset in the terminal device 300, it is unnecessary for the policy server 100 to send the message indicating the priority.

In addition, the policy server 100 sends SIP session control information to the SIP server 21. The SIP session control information serves as an instruction to establish a SIP session between the data connect adapters in the wireless APs 400 and 700. If a SIP session is established between the data connect adapters in the wireless APs 400 and 700, communication between the terminal devices 300 and 800 is available by using the SIP session as a tunnel.

Furthermore, the policy server 100 sends a policy information setting instruction to the routers 500 and 600 and the wireless APs 400 and 700. The routers 500 and 600 and the wireless APs 400 and 700 set their internal information so as to perform communication between the terminal devices 300 and 800 with a quality in accordance with the priority indicated by the policy information.

Subsequently, communication between the terminal devices 300 and 800 is performed. Communication data is transmitted from the wireless AP 400 to the wireless AP 700 via the router 500 and the router 600. At that time, the terminal device 300 serving as a connection source sets the user ID of the user who operates the terminal device 300 in the packet to be transmitted. In addition, the terminal device 800 serving as a connection destination sets the user ID of the user who operates the terminal device 300 serving as the connection source in a packet to be transmitted. The user ID can be set in the header of the packet. The wireless APs 400 and 700 and the routers 500 and 600 determine the communication quality on the basis of the user ID indicated by the packet and relay the packet. In this manner, in each of the networks, communication is performed with a quality in accordance with the service level of the agreement signed by the user of the terminal device 300 serving as the connection source.

The functions of the units used for the priority control according to the second exemplary embodiment are described next.

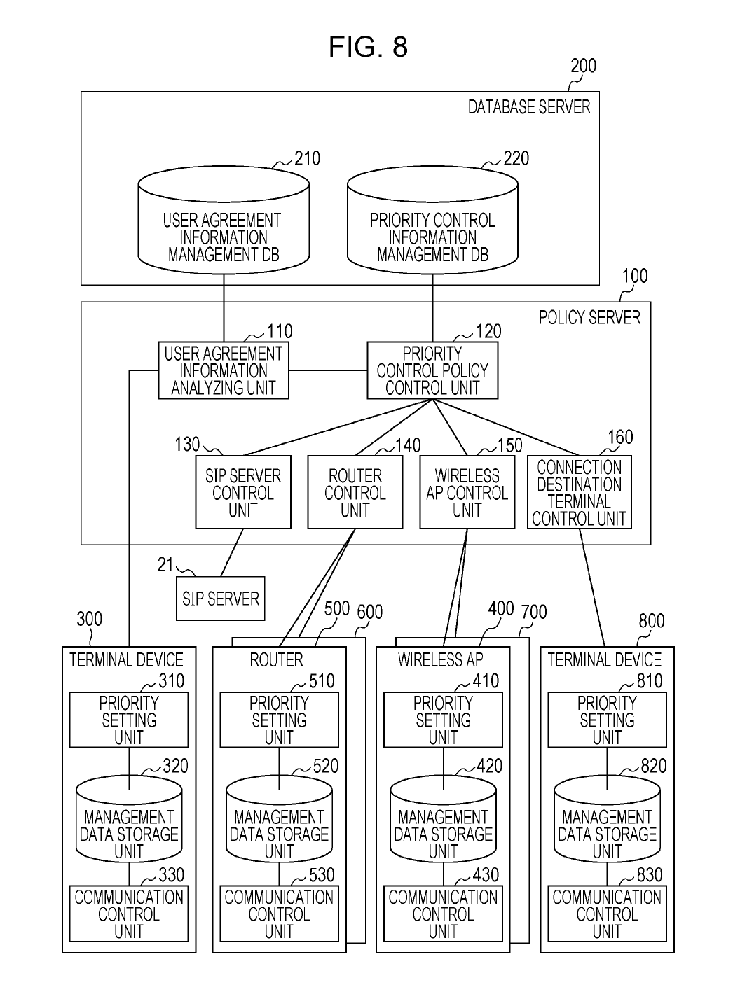

FIG. 8 is a block diagram of the function of each of the units according to the second exemplary embodiment. Note that in the example illustrated in FIG. 8, the priority control is performed in response to a request received from the terminal device 300. Thus, a communication path between the policy server 100 and the terminal device 300 and a communication path between the policy server 100 and the terminal device 800 are illustrated.

The database server 200 contains a user agreement information management database (DB) 210 and a priority control information management DB 220. The information regarding the agreement signed by a user who utilizes the system is stored in the user agreement information management DB 210, and information regarding communication currently being performed for each of the users is stored in the priority control information management DB 220.

The policy server 100 includes a user agreement information analyzing unit 110, a priority control policy control unit 120, a SIP server control unit 130, a router control unit 140, a wireless AP control unit 150, and a connection destination terminal control unit 160.

The user agreement information analyzing unit 110 determines the priority for the user who requested the priority control on the basis of the user agreement information. The priority control policy control unit 120 instructs the relaying apparatuses in the communication path to set the priority control policy regarding communication between the terminal devices.

The SIP server control unit 130 controls the SIP server 21. For example, the SIP server control unit 130 sends, to the SIP server 21, a request for establishing a SIP session between a terminal device that has output the priority control request and a terminal device which is the other party of communication.

The router control unit 140 controls the routers 500 and 600. For example, the router control unit 140 sends a priority policy setting request to the routers 500 and 600.

The wireless AP control unit 150 controls the wireless APs 400 and 700. For example, the wireless AP control unit 150 sends a priority policy setting request to the wireless APs 400 and 700.

The connection destination terminal control unit 160 controls the terminal device 800, which is the connection destination. For example, the connection destination terminal control unit 160 sends a priority policy setting request to the terminal device 800.

The terminal device 300, which is the connection source, includes a priority setting unit 310, a management data storage unit 320, and a communication control unit 330.

When performing communication in which the terminal device 300 serves as the connection destination, the priority setting unit 310 receives the priority policy setting request from the policy server 100. Thereafter, in response to the received priority policy setting request, the priority setting unit 310 stores the priority of the communication in the management data storage unit 320.

The management data storage unit 320 stores information used by the terminal device 300 during the communication. For example, when communication in which the terminal device 300 serves as a caller is performed, the management data storage unit 320 stores information used for the priority control request sent to the policy server 100. Examples of the information used for the priority control request include the address of the policy server 100 and the address of the terminal device 300 itself. In addition, if the terminal device 300 serves as the connection destination, the management data storage unit 320 stores information regarding the priority of the communication.

The communication control unit 330 performs communication with the terminal device 800 through a transmission path including a wireless zone and a wired zone. The communication control unit 330 sends a priority control request to the policy server 100 in response to, for example, an input from the user. In addition, the communication control unit 330 communicates with the terminal device 800 on the basis of the priority indicated by the policy server 100. For example, as the priority in accordance with the agreement signed by the user who operates the terminal device 300 is higher, the communication control unit 330 reduces a wait time used for determining whether another terminal device that communicates with the wireless AP 400 is present.

Like the terminal device 300, the terminal device 800 includes a priority setting unit 810, a management data storage unit 820, and a communication control unit 830. The components of the terminal device 800 has the names and functions that are the same as those of the terminal device 300.

The router 500 includes a priority setting unit 510, a management data storage unit 520, and a communication control unit 530.

When relaying communication data with priority control, the priority setting unit 510 receives a priority policy setting request from the policy server 100. Thereafter, the priority setting unit 510 stores, in the management data storage unit 520, the priority of the communication in accordance with the received priority policy setting request.

The management data storage unit 520 stores information used by the router 500 when the router 500 relays the communication data. For example, the management data storage unit 520 stores information regarding the priority of communication performed by the terminal device 300, which is a caller of communication connection.

The communication control unit 530 controls communication relayed by the router 500. For example, the communication control unit 530 sets a priority in the relayed packet on the basis of the priority of the terminal device 300, which is a source of the relaying communication.

The router 600 has a function similar to that of the router 500.

The wireless AP 400 includes a priority setting unit 410, a management data storage unit 420, and a communication control unit 430. Among these units, the priority setting unit 410 and the management data storage unit 420 have the names and functions that are the same as those of the router 500.

The communication control unit 430 controls communication relayed by the wireless AP 400. For example, when forwarding a packet input from the wirelessly connected terminal device 300 to the router 500, the communication control unit 430 sets a priority in the relayed packet on the basis of the priority of the terminal device 300, which is a source of the relaying communication. In addition, when forwarding a packet input from the router 500 to the terminal device 300, the communication control unit 430 sets a wait time used for determining whether another terminal device is not present in accordance with the priority of the terminal device 300.

The wireless AP 700 has a function similar to that of the wireless AP 400.

Note that the lines between the components illustrated in FIG. 8 represent part of the communication path. A communication path other than the illustrated communication path can be set. In addition, the user agreement information analyzing unit 110 illustrated in FIG. 8 is an example of the determination unit 1b according to the first exemplary embodiment illustrated in FIG. 1. The functions of the priority control policy control unit 120, the SIP server control unit 130, the router control unit 140, the wireless AP control unit 150, and the connection destination terminal control unit 160 illustrated in FIG. 8 are examples of the function of the setting unit 1c according to the first exemplary embodiment illustrated in FIG. 1. The database server 200 illustrated in FIG. 8 is an example of the storage unit 1a according to the first exemplary embodiment illustrated in FIG. 1.

The information stored in each of the units is described next.

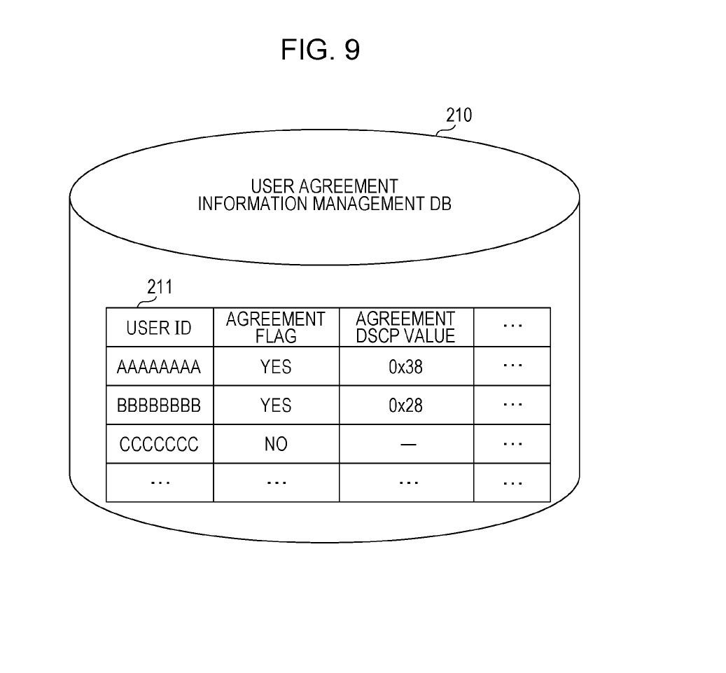

FIG. 9 illustrates an example of the data structure of a user agreement information management DB. The user agreement information management DB 210 contains a user agreement information table 211. The user agreement information table 211 is a data table having the content of the user agreement (the user agreement information) registered therein. The user agreement information table 211 has, for example, a user ID entry, an agreement flag entry, and an agreement DSCP value entry.

The identification information on the user who uses the system (the user ID) is set in the user ID entry. Information as to whether an agreement related to the communication quality is settled with the user is set in the agreement flag entry. A DSCP value based on the agreement signed by the user is set in the agreement DSCP value entry. The DSCP value for each of the users can be identified on the basis of such user agreement information.

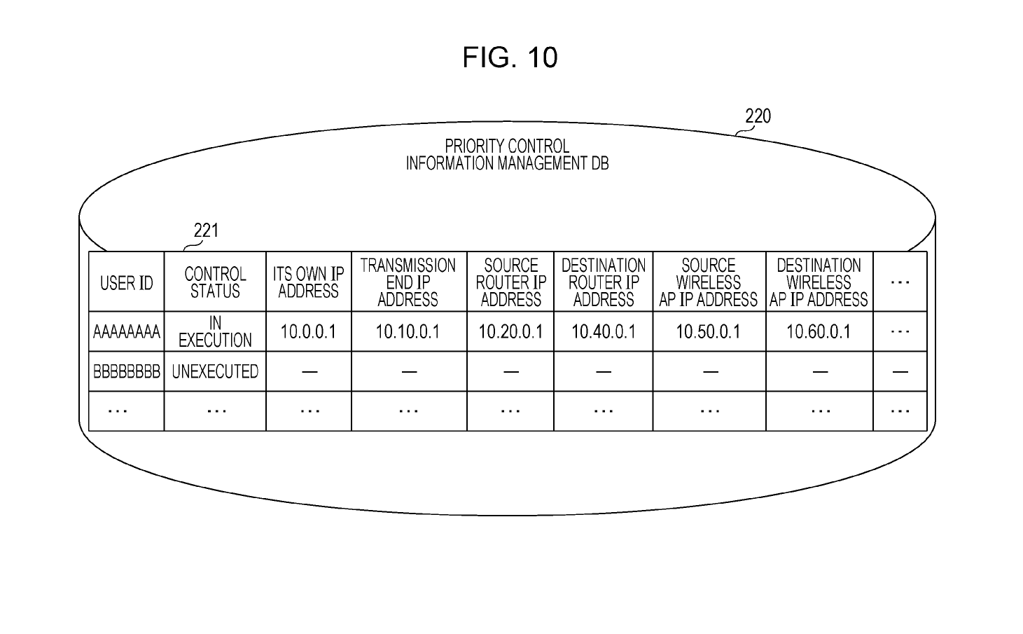

FIG. 10 illustrates an example of the data structure of a priority control information management DB. The priority control information management DB 220 contains a priority control information table 221. The priority control information table 221 is a data table having a priority control state of the user communication (priority control information) registered therein. The priority control information table 221 includes a user ID entry, a control status entry, a its own IP address entry, a transmission end IP address entry, a source router IP address entry, a destination router IP address entry, a source wireless AP IP address entry, and a destination wireless AP IP address entry.

The user ID of the user who uses the system is set in the user ID entry. The status of the priority control in the terminal device operated by the user is set in the control status entry. For example, if the communication is under the priority control, the status “In Execution” is set. However, if the communication is not under the priority control, the status “Unexecuted” is set. The IP address of the terminal device operated by the user (a connection source terminal device) is set in the its own IP address entry. The IP address of the terminal device serving as the other party of communication of the user (a connection destination terminal device) is set in the transmission end IP address entry. The IP address of an edge router of the core network for the terminal device operated by the user in the transmission path between the terminal device operated by the user and the terminal device serving as the other party of communication of the user (the connection destination terminal device) is set in the source router IP address entry. The IP address of an edge router of the core network for the terminal device serving as the other party of communication of the user in the transmission path between the terminal device operated by the user and the terminal device serving as the other party of communication is set in the destination router IP address entry. The IP address of a wireless AP to which the terminal device operated by the user is connected via the wireless network is set in the source wireless AP IP address entry. The IP address of a wireless AP to which the terminal device serving as the other party of communication is connected via the wireless network is set in the destination wireless AP IP address entry.

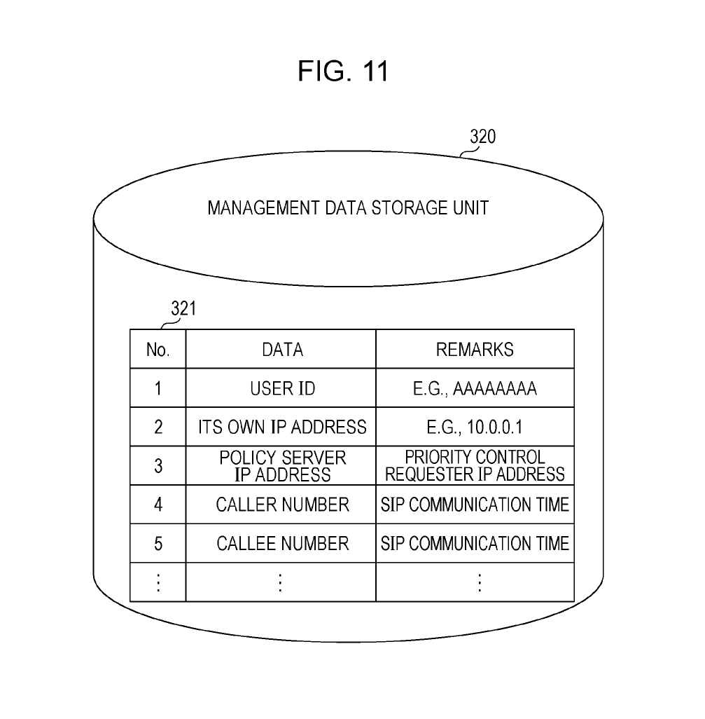

FIG. 11 illustrates an example of the data structure of a management data storage unit of the terminal device serving as the connection source. The management data storage unit 320 of the terminal device 300 serving as the connection source stores terminal management information 321. The terminal management information 321 includes a plurality of data items each having a management number (No.) assigned thereto. For example, the terminal management information 321 includes a user ID, its own IP address, a policy server IP address, a caller number, and a called number. The user ID represents the identification information on the user who operates the terminal device 300. Its own IP address represents the IP address of the terminal device 300. The policy server IP address represents the IP address of the policy server 100. The caller number represents the identification number of the terminal device 300 (e.g., the telephone number). The called number represents the identification number of the terminal device serving as the other party of communication (e.g., the telephone number). The caller number and the called number are used for SIP communication.

Note that when the SIP session is started, the IP address of the terminal device 300 serving as the connection destination is sent from the SIP server 21. The received IP address is appended to, for example, the terminal management information 321.

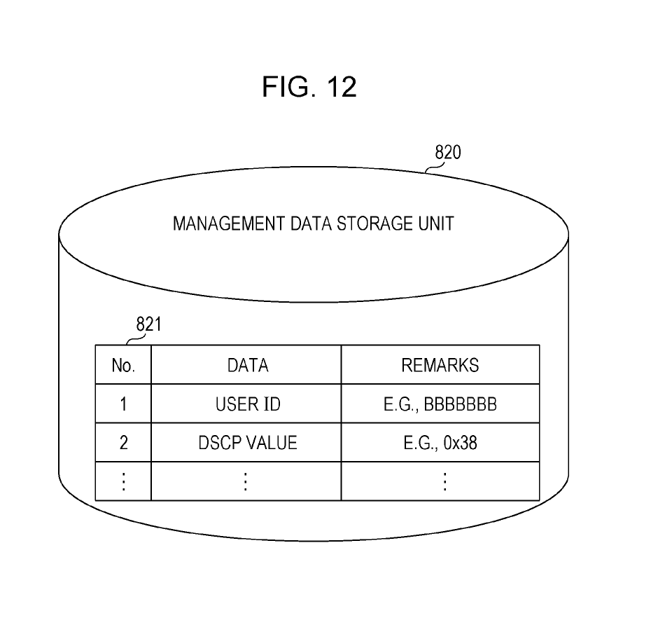

FIG. 12 illustrates an example of the data structure of a management data storage unit of the terminal device serving as the connection destination. The management data storage unit 820 of the terminal device 800 serving as the connection destination stores terminal management information 821. The terminal management information 821 includes a plurality of data items each having a management number (No.) assigned thereto. For example, the terminal management information 821 includes a user ID and a DSCP value. The user ID represents the IP address of the terminal device 800. The DSCP value indicates the priority based on the service level under the agreement signed by the user of the terminal device 300 serving as the connection source.

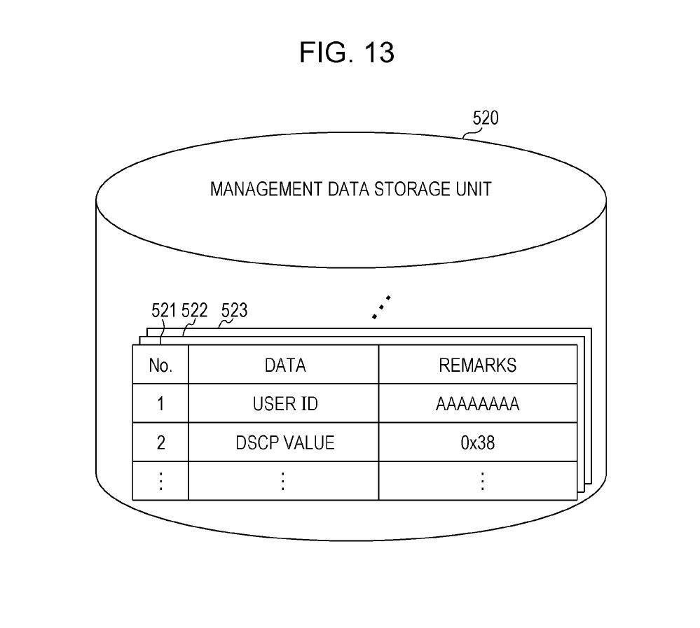

FIG. 13 illustrates an example of the data structure of a management data storage unit of the router. The management data storage unit 520 of the router 500 stores router management information items 521, 522, 523, . . . each for one of the users who perform priority control communication via the router 500. Each of the router management information items 521, 522, 523, . . . includes a plurality of data items each having a management number (No.) assigned thereto. For example, each of the router management information items 521, 522, 523, . . . includes a user ID and a DSCP value. The user ID represents the user who operates the terminal device serving as the connection source in communication via the router 500. The DSCP value indicates the priority based on the service level under the agreement signed by the user serving as the connection source.

Note that the management data storage unit of the router 600 stores router management information having a data structure similar to that illustrated in FIG. 13.

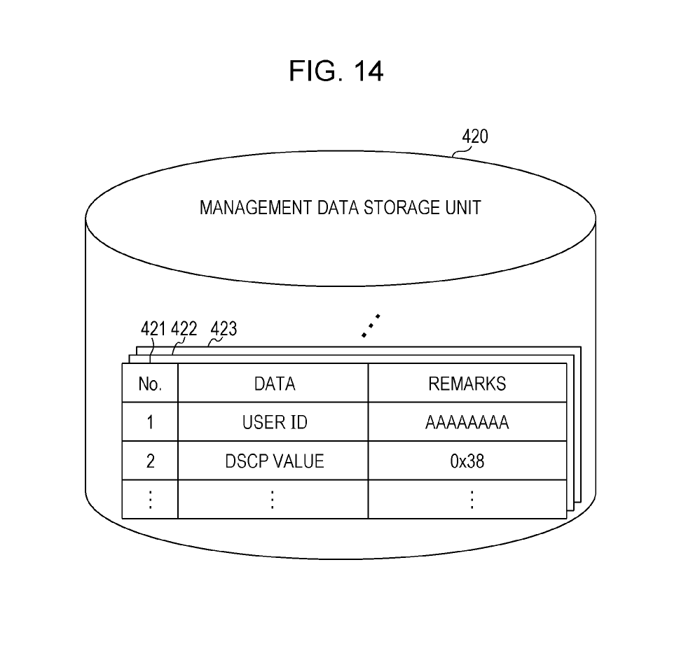

FIG. 14 illustrated an example of the data structure of a management data storage unit of the wireless AP. The management data storage unit 420 of the wireless AP 400 stores wireless AP management information items 421, 422, 423, . . . each for one of the users who perform priority control communication via the wireless AP 400. Each of the AP management information items 421, 422, 423, . . . includes a plurality of data items each having a management number (No.) assigned thereto. For example, each of the AP management information items 421, 422, 423, . . . includes a user ID and a DSCP value. The user ID represents the user who operates the terminal device serving as the connection source in communication via the wireless AP 400. The DSCP value indicates the priority based on the service level under the agreement signed by the user serving as the connection source.

Note that the management data storage unit of the wireless AP 700 stores wireless AP management information having a data structure similar to that illustrated in FIG. 14.

In the system having the above-described configuration, communication with priority control is performed between the terminal devices 300 and 800. The exemplary procedure of communication with priority control is described in detail below.

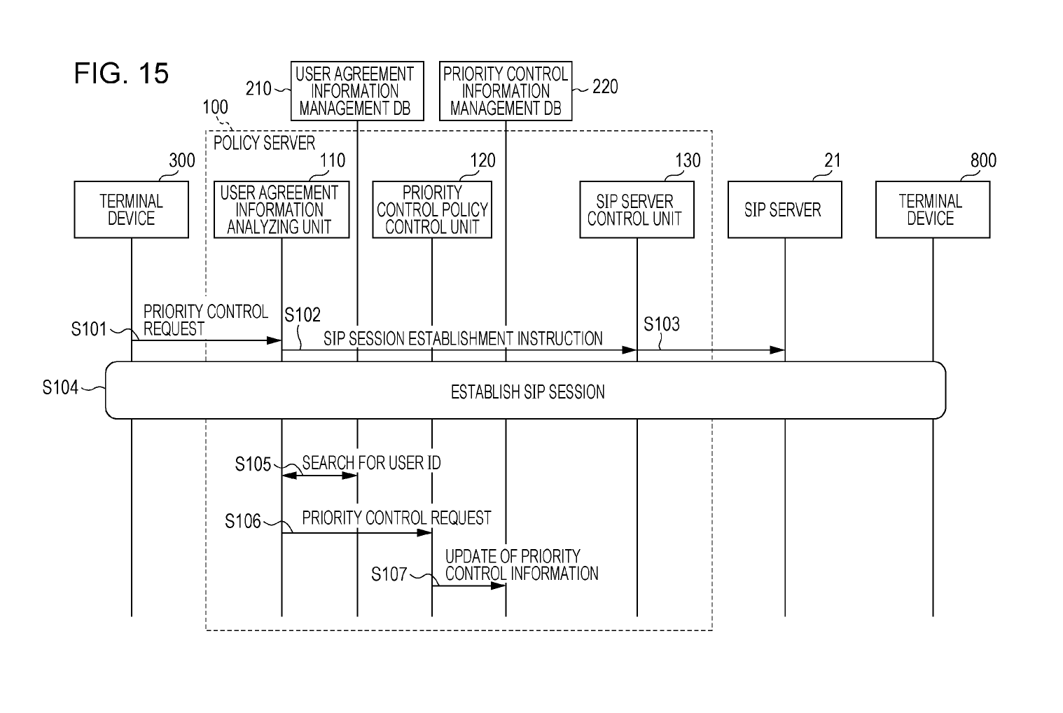

FIG. 15 is a sequence diagram illustrating a first half of the communication procedure with priority control. The terminal device 300 sends a priority control request to the policy server 100 first (step S101). For example, upon receiving, from a user, a connection instruction including the identification number of the transmission end, the communication control unit 330 of the terminal device 300 refers to the terminal management information 321 in the management data storage unit 320. Subsequently, the communication control unit 330 transmits a packet serving as a priority control request to the destination indicated by the policy server IP address contained in the terminal management information 321. The packet serving as the priority control request contains, for example, the user ID of the user who operates the terminal device 300, its own IP address, the caller number, and the called number.

Upon receiving the priority control request, the user agreement information analyzing unit 110 of the policy server 100 analyzes the priority control request. Thereafter, the user agreement information analyzing unit 110 instructs the SIP server control unit 130 via the priority control policy control unit 120 to establish a SIP session between the terminal device 300 serving as the connection source and the terminal device 800 serving as the connection destination (step S102).

Upon receiving the instruction to establish a SIP session, the SIP server control unit 130 sends, to the SIP server 21, a SIP session establishment request between the terminal device 300 and the terminal device 800 (step S103). Thus, the SIP session is established between the terminal device 300 and the terminal device 800 under the control of the SIP server 21 (step S104). For example, the SIP server 21 instructs the wireless APs 400 and 700 and the routers 500 and 600 to establish a SIP session. Thereafter, a SIP session is established between the data connect adapters of the wireless APs 400 and 700. The routers 500 and 600 manages the communication path of the established SIP session. In addition, each of the terminal devices 300 and 800 receives the IP address of the other party of communication thereof from the SIP server 21. Thus, the terminal devices 300 and 800 can communicate with each other using the SIP session established between the wireless APs 400 and 700 as a tunnel.

Subsequently, the user agreement information analyzing unit 110 searches for information in the user agreement information management DB 210 using the user ID of the user acquired from the terminal device 300 (step S105). Thus, the user agreement information analyzing unit 110 acquires the agreement flag and the agreement DSCP value for the user. Thereafter, the user agreement information analyzing unit 110 sends a priority control request to the priority control policy control unit 120 (step S106).

Upon receiving the priority control request, the priority control policy control unit 120 accesses the priority control information management DB 220 and updates the priority control information (step S107). For example, the priority control policy control unit 120 sets the control status for the user who operates the terminal device 300 to “In Execution” and registers information regarding the established SIP session.

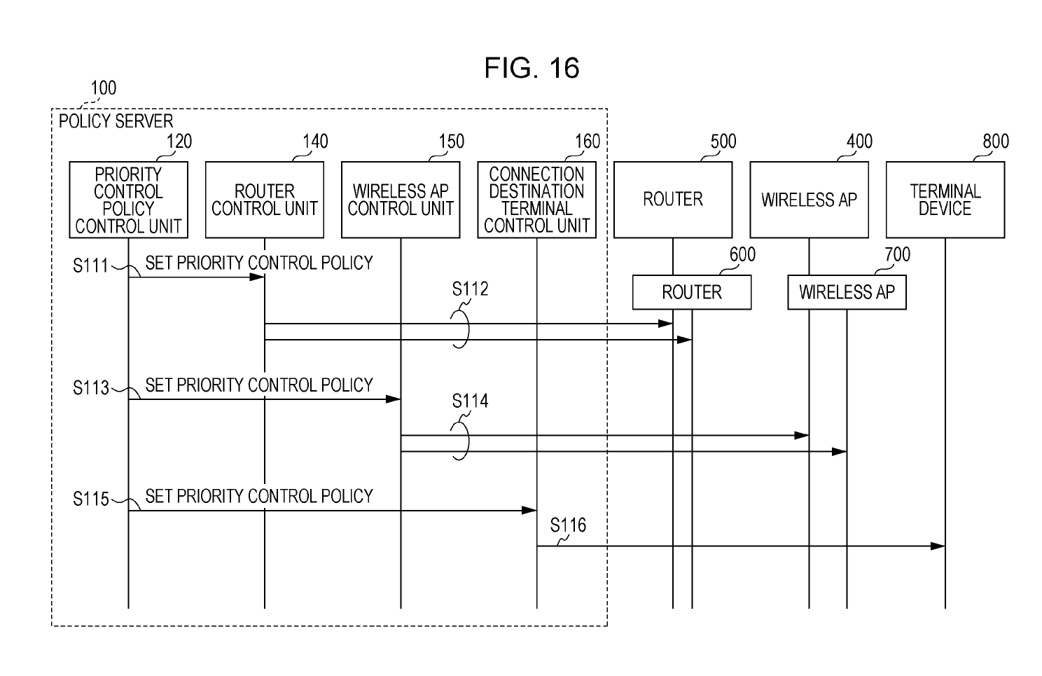

FIG. 16 is a sequence diagram of the second half of the communication procedure with priority control. The priority control policy control unit 120 instructs the router control unit 140 to set a priority control policy (step S111). The router control unit 140 sets the priority control policy for the routers 500 and 600 as instructed by the priority control policy control unit 120 (step S112).

In addition, the priority control policy control unit 120 instructs the wireless AP control unit 150 to set the priority control policy (step S113). The wireless AP control unit 150 sets the priority control policy for the wireless APs 400 and 700 as instructed by the priority control policy control unit 120 (step S114).

Furthermore, the priority control policy control unit 120 instructs the connection destination terminal control unit 160 at the connection destination to set the priority control policy (step S115). The connection destination terminal control unit 160 sets the priority control policy for the terminal device 800 serving as the connection destination as instructed by the priority control policy control unit 120 (step S116).

In this manner, the priority control policy is set for all of the communication apparatuses in the transmission path between the terminal devices 300 and 800. Note that according to the second exemplary embodiment, the terminal device 300 has a priority preset in accordance with its own priority control policy. After the setting of the priority control policy is completed, communication having a quality in accordance with the priority is performed between the terminal devices 300 and 800.

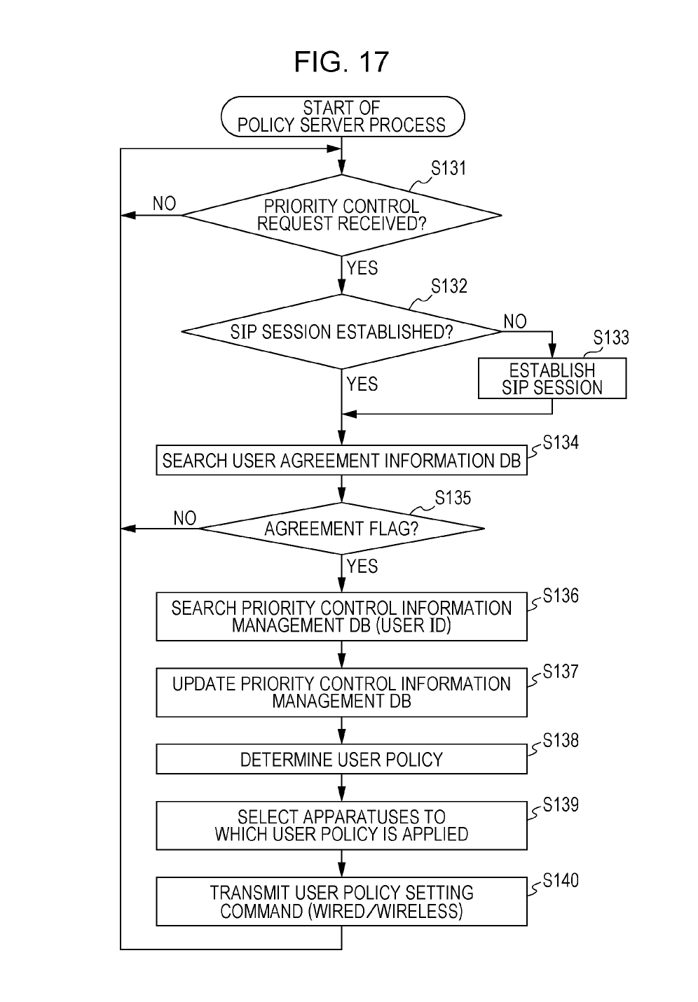

The processing performed by each of the units to realize the priority control is described in more detail below. FIG. 17 is a flowchart illustrating an example of the procedure of processing performed by the policy server.

(Step S131) The user agreement information analyzing unit 110 of the policy server 100 determines whether it has received a priority control request. If the user agreement information analyzing unit 110 receives a priority control request, the processing proceeds to step S132. However, if the user agreement information analyzing unit 110 does not receive a priority control request, the process in step S131 is repeated.

(Step S132) Upon receiving the priority control request, the user agreement information analyzing unit 110 determines whether a SIP session corresponding to the terminal device 300, which is the source of the priority control request, has been established. If the SIP session has been established, the processing proceeds to step S134. However, if the SIP session has not been established, the processing proceeds to step S133.

(Step S133) If a SIP session has not been established, the user agreement information analyzing unit 110 sends a packet serving as the priority control request to the priority control policy control unit 120 and, thus, instructs the priority control policy control unit 120 to establish a SIP session. Upon receiving the instruction, the priority control policy control unit 120 sends an instruction to establish a SIP session via the SIP server control unit 130. At that time, using the caller number and the called number contained in the priority control request, the priority control policy control unit 120 specifies the terminal devices 300 and 800 between which the SIP session is to be established. The SIP server control unit 130 sends a SIP session establishment request to the SIP server 21. Thus, the SIP session is established by the SIP server 21. At that time, the SIP server 21 sends, to the policy server 100, a message including the IP addresses of the routers 500 and 600 and the wireless APs 400 and 700 through which the packet passed in the SIP session establishment and the IP address of the terminal device 800 serving as the connection destination. The information received from the SIP server 21 is delivered to the user agreement information analyzing unit 110.

(Step S134) After the SIP session is established, the user agreement information analyzing unit 110 searches the user agreement information management DB 210 for the agreement information regarding the user who operates the terminal device 300 using the user ID in the packet sent from the terminal device 300. In this manner, the user agreement information analyzing unit 110 acquires the agreement flag and the agreement DSCP value (if an agreement is settled) for the user.

(Step S135) The user agreement information analyzing unit 110 determines whether the agreement flag is set to “Yes” or “No”. If the agreement flag is set to “Yes” (i.e., an agreement is settled), the processing proceeds to step S136. However, if the agreement flag is set to “No” (i.e., an agreement is not settled), the processing proceeds to step S131. Thus, if the agreement is not settled, priority control is not performed.

(Step S136) If the agreement is settled, the user agreement information analyzing unit 110 delivers the information regarding the established SIP session to the priority control policy control unit 120. The information delivered to the priority control policy control unit 120 contains, for example, the user ID, the agreement DSCP value, its own IP address, the transmission end IP address, the IP addresses of the routers 500 and 600, and the IP addresses of the wireless APs 400 and 700. Upon receiving the SIP session information, the priority control policy control unit 120 searches the priority control information management DB 220 using the received user ID.

(Step S137) The priority control policy control unit 120 updates a record found in the search (i.e., the priority control information). For example, the priority control policy control unit 120 changes the control status in the found priority control information to “In Execution”. In addition, the priority control policy control unit 120 sets, in the priority control information, its own IP address, the transmission end IP address, and the IP addresses of the routers 500 and 600 and the wireless APs 400 and 700 received from the user agreement information analyzing unit 110.

(Step S138) The priority control policy control unit 120 selects the agreement DSCP value for the received user ID as a user policy.

(Step S139) the priority control policy control unit 120 selects the routers 500 and 600, the wireless APs 400 and 700, and the terminal device 800 serving as the connection destination as the targets of setting the user policy.

(Step S140) The priority control policy control unit 120 instructs the router control unit 140, the wireless AP control unit 150, and the connection destination terminal control unit 160 to set the user policy for the targets of user policy setting. At that time, the priority control policy control unit 120 delivers the user IS, the agreement DSCP value, and the IP addresses of the routers 500 and 600 to the router control unit 140. In addition, the priority control policy control unit 120 delivers the user ID, the agreement DSCP value, and the IP addresses of the wireless APs 400 and 700 to the wireless AP control unit 150. Furthermore, the priority control policy control unit 120 delivers the user ID, the agreement DSCP value, and the IP address of the terminal device 800 to the connection destination terminal control unit 160. Thereafter, the router control unit 140 sets the priority control policy for the routers 500 and 600. For example, the router control unit 140 sends a user policy setting command including a pair consisting of the user ID and the DSCP value to the routers 500 and 600. In addition, the wireless AP control unit 150 sets the priority control policy for the wireless APs 400 and 700. For example, the wireless AP control unit 150 sends a user policy setting command including a pair consisting of the user ID and the DSCP value to the wireless APs 400 and 700. Furthermore, the connection destination terminal control unit 160 sets the priority control policy for the terminal device 800. For example, the connection destination terminal control unit 160 sends a user policy setting command including a pair consisting of the user ID and the DSCP value to the terminal device 800.

The processing performed by the routers 500 and 600 is described in detail next.

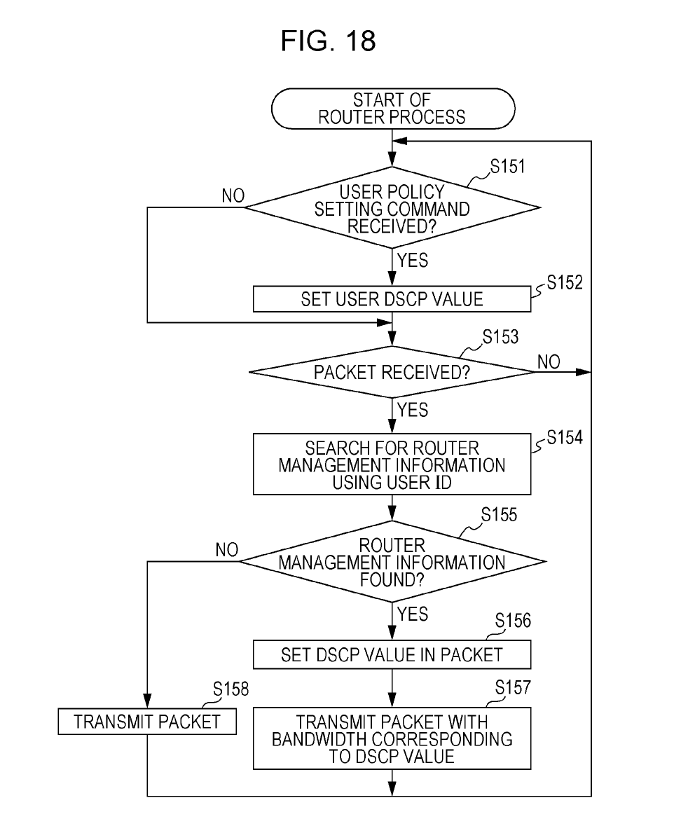

FIG. 18 is a flowchart illustrating an example of the procedure of processing performed by the router.

(Step S151) The priority setting unit 510 determines whether it has received the user policy setting command from the policy server 100. If the priority setting unit 510 has received the user policy setting command, the processing proceeds to step S152. However, if the priority setting unit 510 has not received the user policy setting command, the processing proceeds to step S153.

(Step S152) Upon receiving the user policy setting command, the priority setting unit 510 sets the DSCP value for the user in the management data storage unit 520. For example, the priority setting unit 510 stores, in the management data storage unit 520, the router management information including the user ID and the DSCP value contained in the user policy setting command.

Note that a SIP session ID may be included in the router management information. In such a case, only when a session corresponding to the SIP session ID is established, the router management information corresponding to the SIP session ID is held in the management data storage unit 520. For example, if the SIP session is closed, the priority setting unit 510 deletes the router management information regarding the closed SIP session from the management data storage unit 520. Closing of the SIP session can be detected by, for example, a message sent from the SIP server 21. In addition, a SIP session in which communication is not performed for a predetermined period of time may be considered as a closed session.

(Step S153) The communication control unit 530 determines whether a data communication packet has been received. If a data communication packet has been received, the processing proceeds to step S154. However, if a data communication packet has not been received, the processing proceeds to step S151.

(Step S154) The communication control unit 530 searches the management data storage unit 520 for the router management information using the user ID contained in the packet.

(Step S155) The communication control unit 530 determines whether in step S154, router management information corresponding to the user ID can be detected. If the router management information can be detected, the processing proceeds to step S156. However, if the router management information is not detected, the processing proceeds to step S158. An example of the case in which the router management information is not detected is the case in which a communication packet without the priority control is received.

(Step S156) If the router management information corresponding to the user ID is found, the communication control unit 530 sets the DSCP value indicated by the router management information in the packet.

(Step S157) The communication control unit 530 performs bandwidth control in accordance with the DSCP value in the packet and forwards the received packet. For example, as the packet has a higher DSCP value, the communication control unit 530 more preferentially transmits the packet. Thereafter, the processing proceeds to step S151.

(Step S158) However, if the router management information corresponding to the user ID is not found, the communication control unit 530 transmits the packet without performing the priority control. Thereafter, the processing proceeds to step S151.

In this manner, the router 500 forwards the packet with a quality in accordance with the priority of the terminal device 300 serving as the source. Note that the router 600 forwards a packet through the processing that is similar to the processing illustrated in FIG. 18.

The processing performed by the wireless APs 400 and 700 is described in detail next.

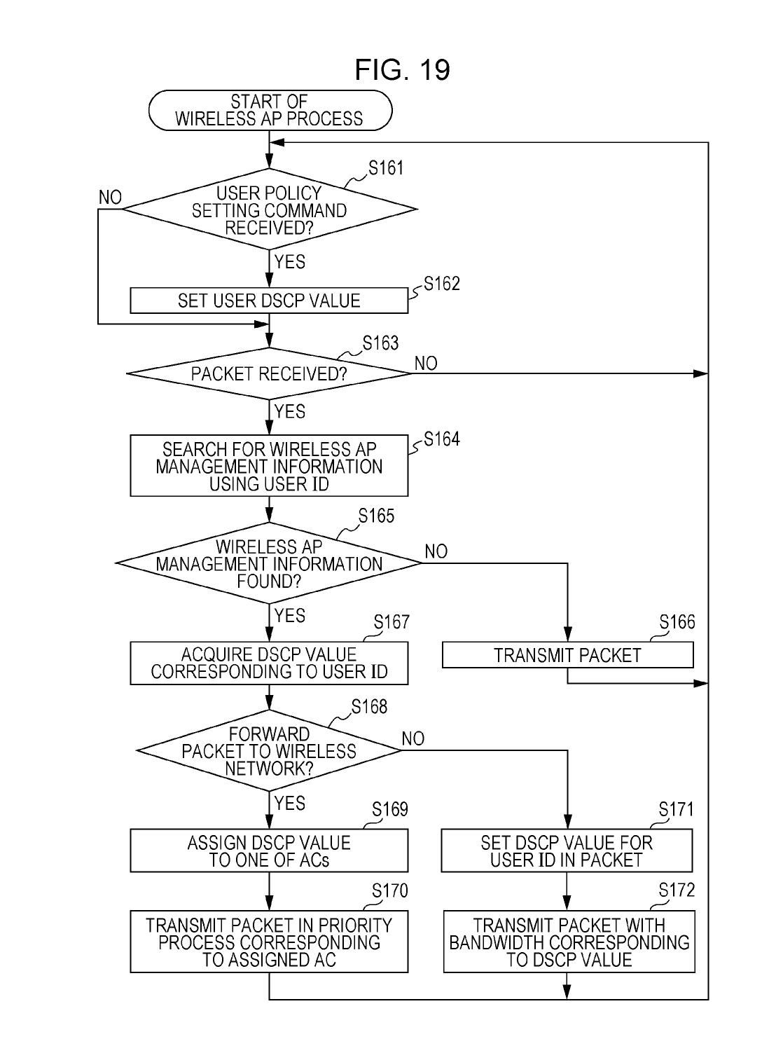

FIG. 19 is a flowchart illustrating an example of the procedure of processing performed by a wireless AP.

(Step S161) The priority setting unit 410 determines whether it has received a user policy setting command from the policy server 100. If the user policy setting command has been received, the processing proceeds to step S162. However, if the user policy setting command has not been received, the processing proceeds to step S163.

(Step S162) Upon receiving the user policy setting command, the priority setting unit 410 sets the DSCP value for the user in the management data storage unit 420. For example, the priority setting unit 410 stores, in the management data storage unit 420, the wireless AP management information including the user ID and the DSCP value contained in the user policy setting command.

Note that a SIP session ID may be included in the wireless AP management information. In such a case, only when a session corresponding to the SIP session ID is established, the wireless AP management information corresponding to the SIP session ID is held in the management data storage unit 420. For example, if the SIP session is closed, the priority setting unit 410 deletes the wireless AP management information regarding the closed SIP session from the management data storage unit 420. Closing of the SIP session can be detected by, for example, a message sent from the SIP server 21. In addition, if the communication with the terminal device 300 via the wireless network is disconnected, it may be determined that the SIP session is also closed.

(Step S163) The communication control unit 430 determines whether a data communication packet has been received. If a data communication packet has been received, the processing proceeds to step S164. However, if a data communication packet has not been received, the processing proceeds to step S161.

(Step S164) The communication control unit 430 searches the management data storage unit 420 for the wireless AP management information using the user ID contained in the packet.

(Step S165) The communication control unit 430 determines whether in step S164, the wireless AP management information corresponding to the user ID can be detected. If the wireless AP management information can be detected, the processing proceeds to step S167. However, if the wireless AP management information is not detected, the processing proceeds to step S166. An example of the case in which the wireless AP management information is not detected is the case in which a communication packet without the priority control is received.

(Step S166) If the wireless AP management information corresponding to the user ID is not found, the communication control unit 430 forwards the packet without performing priority control. Thereafter, the processing proceeds to step S161.

(Step S167) The communication control unit 430 acquires the DSCP value corresponding to the user ID contained in the packet from the wireless AP management information detected in step S164.

(Step S168) The communication control unit 430 determines whether the forwarding destination of the packet is a wireless network. If the forwarding destination of the packet is a wireless network, the processing proceeds to step S169. However, if the forwarding destination of the packet is not a wireless network, the processing proceeds to step S171.

(Step S169) If the packet is forwarded to a wireless network, the communication control unit 430 assigns the DSCP value to one of access categories (ACs). For example, as the DSCP value is higher, the DSCP value is assigned to one of the ACs having a higher priority.

(Step S170) The communication control unit 430 forwards the packet to the terminal device 300 through a priority process (the quality) in accordance with the assigned AC. Thereafter, the processing proceeds to step S161.

(Step S171) If the packet is forwarded to a network other than a wireless network, the communication control unit 430 sets, in the packet, the DSCP value for the user ID indicated by the packet.

(Step S172) The communication control unit 430 performs bandwidth control in accordance with the DSCP value in the packet and forwards the received packet. For example, as a packet has a higher DSCP value, the communication control unit 430 more preferentially transmits the packet. Thereafter, the processing proceeds to step S161.

In this manner, the wireless AP 400 forwards the packet with a quality in accordance with the priority of the terminal device 300 serving as the source. Note that the wireless AP 700 forwards a packet through the processing that is similar to the processing illustrated in FIG. 19.

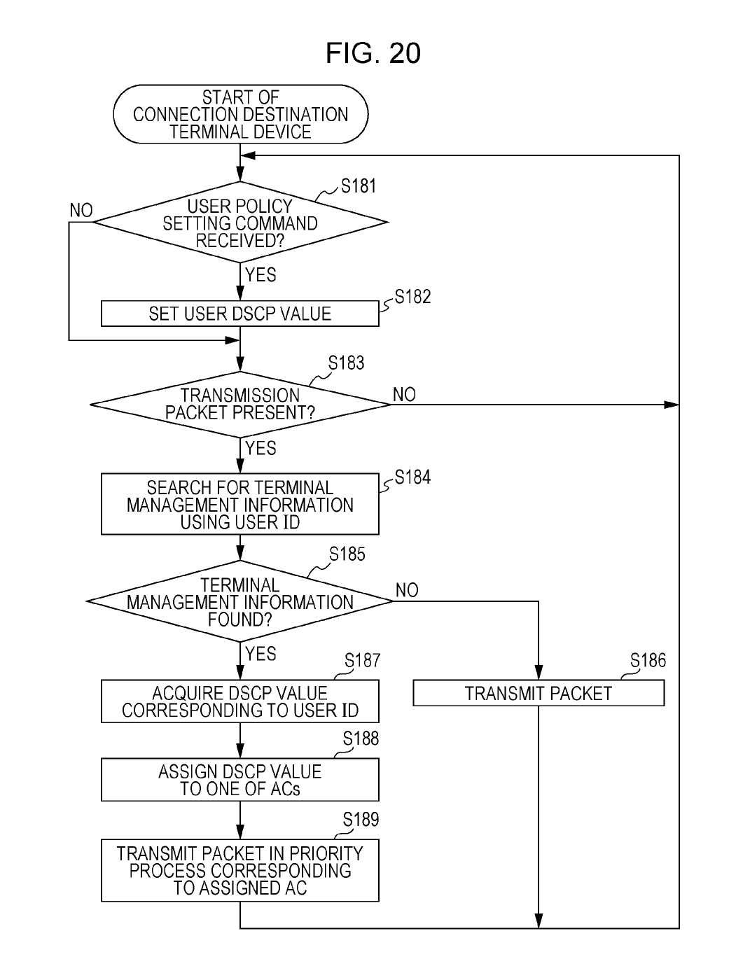

The processing performed by the terminal device 800 serving as the connection destination is described in detail next. FIG. 20 is a flowchart illustrating an example of the procedure of processing performed by a terminal device serving as the connection destination.

(Step S181) The priority setting unit 810 determines whether it has received a user policy setting command from the policy server 100. If the priority setting unit 810 has received a user policy setting command, the processing proceeds to step S182. However, if the priority setting unit 810 has not received a user policy setting command, the processing proceeds to step S183.

(Step S182) Upon receiving a user policy setting command, the priority setting unit 810 stores, in the management data storage unit 820, the terminal management information 821 including the user ID and the DSCP value contained in the user policy setting command.

Note that a SIP session ID may be included in the terminal management information 821. In such a case, only when a session corresponding to the SIP session ID is established, the terminal management information 821 corresponding to the SIP session ID is held in the management data storage unit 820. For example, if the SIP session is closed, the priority setting unit 810 deletes the terminal management information 821 from the management data storage unit 820.

(Step S183) The communication control unit 830 determines whether a packet to be transmitted is present. If a packet to be transmitted is present, the processing proceeds to step S184. However, if a packet to be transmitted is present, the processing proceeds to step S181.

(Step S184) The communication control unit 830 searches the management data storage unit 820 for terminal management information using the user ID of the other party of communication.

(Step S185) The communication control unit 830 determines whether in step S184, terminal management information corresponding to the user ID can be detected. If the terminal management information can be detected, the processing proceeds to step S187. However, if the terminal management information is not detected, the processing proceeds to step S186. An example of the case in which the terminal management information is not detected is the case in which a communication packet without the priority control is transmitted.

(Step S186) If the terminal management information corresponding to the user ID is not found, the communication control unit 830 transmits the packet without performing the priority control. Thereafter, the processing proceeds to step S181.

(Step S187) The communication control unit 830 acquires the DSCP value corresponding to the user ID of the other party of communication from the terminal management information detected in step S184.

(Step S188) The communication control unit 830 assigns the DSCP value to one of ACs of WMM.

(Step S189) The communication control unit 830 transmits the packet through a priority process (the quality) in accordance with the assigned AC. Thereafter, the processing proceeds to step S181.

In this manner, the terminal device 800 serving as the connection destination can transmits a packet with a quality in accordance with the priority of the terminal device 300 serving as the connection source.

According to the second exemplary embodiment, the terminal device 300 serving as the connection source sets the quality (one of the ACs) of a packet to be transmitted in advance. Accordingly, the terminal device 800 serving as the connection destination performs the processing in only steps S183 and S189 among the steps illustrated in FIG. 20 and transmits the packet. Note that the terminal device 300 may receive the result of determination of the service level in the agreement from the policy server 100 and may select one of the ACs in accordance with the received result. In such a case, the terminal device 300 serving as the connection source also transmits a packet in the same manner as illustrated in FIG. 20.

Cooperation between the priority control of wired packet transmission and the priority control of wireless packet transmission is described next with reference to a particular example.

In the second exemplary embodiment, a priority is defined using the DSCP value for the wired networks 22 to 24, and a priority is defined using WMM for the wired networks (the wireless networks 25 and 26). Note that WMM is a function of transmitting a packet to a wireless LAN terminal under priority control. WMM is defined by the standard IEEE 802.11e. By using WMM, a packet of voice or video can be preferentially transmitted even when traffic is heavy. Thus, interruptions in communication can be reduced.

In WMM, a packet to be wirelessly sent falls into one of four ACs on the basis of the DSCP value of the IP packet. The four ACs are labeled as: AC_VO (voice), AC_VI (video), AC_BE (best effort), and AC_BK (background) (AC_VO is the highest and AC_BK is the lowest). Each of the wireless APs 400 and 700 and the terminal devices 300 and 800 has a send queue for each of ACs. If packets are waiting in the sent queues, the packet in the queue for a higher priority AC is preferentially sent.

In addition, in WMM, priority control is performed using Enhanced Distributed Channel Access (EDCA). EDCA is a technique for reducing a wait time (a space time between frames and the range of a random time value) more for data having a higher priority and increasing the probability of a voice packet and a video packet being transmitted. The space time between frames is referred to as Arbitration Inter Frame Space (AIFS). The random time is referred to as Contention Window (CW), which is a random number parameter used for determining a transmission wait time. The wait time after a radio wave disappears is calculated by multiplying CW randomly obtained by a unit time (a slot time) and, thereafter, adding AIFS to the product. In addition, the maximum value of a channel occupation time (Transmission Opportunity (TXOP)) can be determined in accordance with the AC.

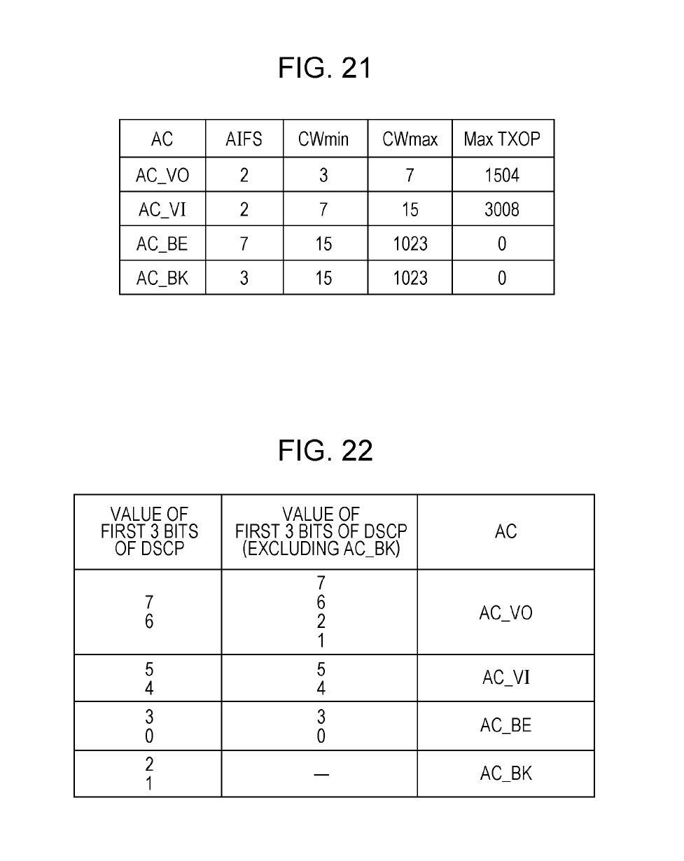

FIG. 21 illustrates an example of the parameters for each of the ACs in EDCA. In FIG. 21, “CWmin” indicates the minimum value of CW, and “CWmax” indicates the minimum value of CW. To determine the wait time, a random value in the range between CWmin and CWmax is selected as the wait time. “Max TXOP” is a maximum value of a channel occupation time.

QoS information regarding the wired communication and the wireless communication can be set in a predetermined field in the header of a packet. The DSCP value used for QoS of wired communication is a 6-bit value. If, in wireless communication, the priority is determined using four ACs, use of only four bits of the six bits is sufficient. For example, first 3 bits of the 6-bit DSCP may be used for the priority. In such a case, by mapping the first 3 bits of the DSCP value into a QoS setting area in a packet for wireless communication, the priority indicated by the DSCP value can be used in wireless communication.

FIG. 22 illustrates an assignment relationship between the DSCP value and the AC. In the example illustrated in FIG. 22, if, for example, the value of the first three bits is 7 or 6 (in decimal), AC is set to “AC_VO”. Such a correspondence relationship is applied to the wireless APs 400 and 700. For example, information indicating the correspondence relationship illustrated in FIG. 22 is held in a flash memory in each of the wireless APs 400 and 700.

Note that in the example illustrated in FIG. 22, the AC “AC_BK” indicates that communication is performed in the background and, thus, real-time communication is unavailable. Accordingly, one of three categories obtained by excluding “AC_BK” from the four ACs may be assigned to the first three bits of the DSCP value. For example, if the value of the first three bits of the DSCP value is “2” or “1”, “AC_VO” of the ACs may be assigned.

Upon receiving a packet, each of the wireless APs 400 and 700 identifies the DSCP value on the basis of the user ID contained in the packet. Upon transmitting a packet to a wireless network, each of the wireless APs 400 and 700 determines the AC on the basis of the DSCP value and sends the packet with the priority based on the AC.

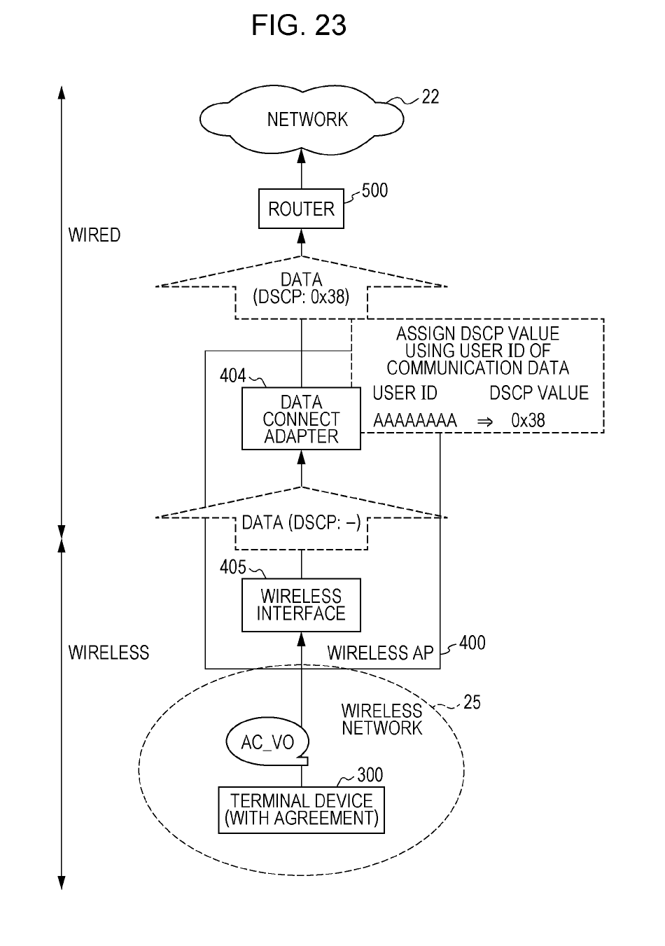

FIG. 23 illustrates an example of the priority control of a packet sent from a terminal device serving as the connection source. In the example illustrated in FIG. 23, the user of the terminal device 300 has signed the agreement for system priority control. Accordingly, for example, a packet with an AC of “AC_VO”, which indicates the highest priority, is sent from the terminal device 300.

The wireless interface 405 of the wireless AP 400 receives the packet and sends the packet to the data connect adapter 404. At that time, a DSCP value is not set. When the data connect adapter 404 sends the packet to the router 500, the data connect adapter 404 sets the DSCP value in the packet. In the example illustrated in FIG. 23, a DSCP value of “0x38” is set.

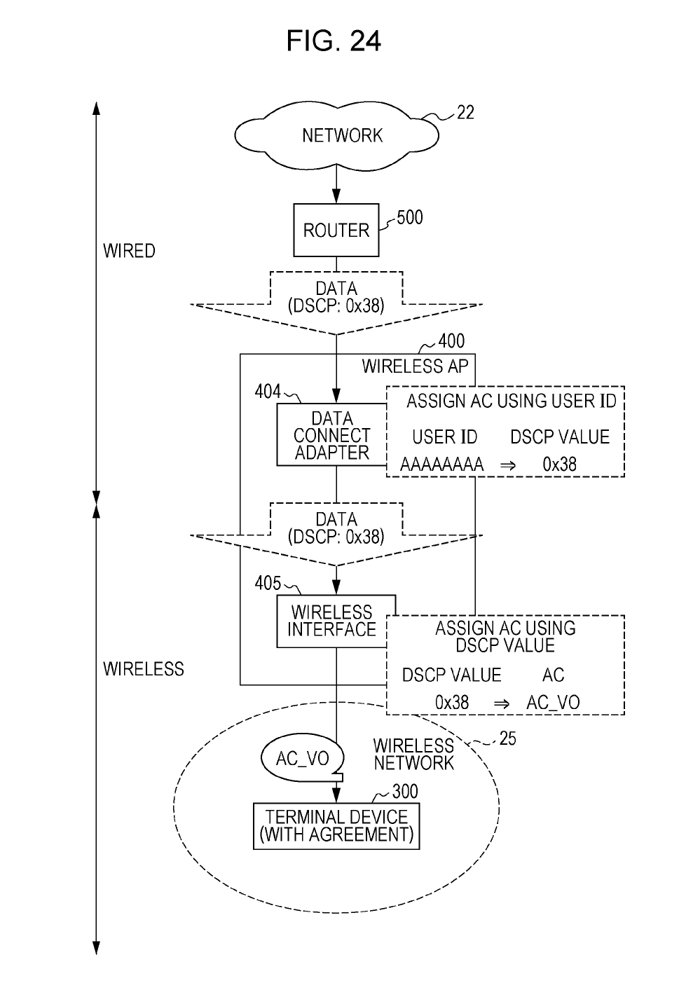

FIG. 24 illustrates an example of the priority control of a packet received by a terminal device serving as the connection source. In the example illustrated in FIG. 24, a user who operates the terminal device 300 has signed an agreement for system priority control. Accordingly, a DSCP value of “0x38” is set in the packet destined for the terminal device 300 and sent from the router 500.

The packet is received by the data connect adapter 404 of the wireless AP 400. The data connect adapter 404 identifies the DSCP value on the basis of the user ID. Thereafter, the data connect adapter 404 sends the packet having the DSCP value set therein to the wireless interface 405. The wireless interface 405 assigns one of ACs to the packet on the basis of the DSCP value. For example, the AC “AC_VO” is assigned. Subsequently, the wireless interface 405 sends the packet to the terminal device 300 with the priority of the assigned AC.

When assigning one of the ACs, the wireless interface 405 maps the first three bits of the DSCP value in the IP packet forwarded from the data connect adapter 404, for example, to the header of a wireless communication frame.

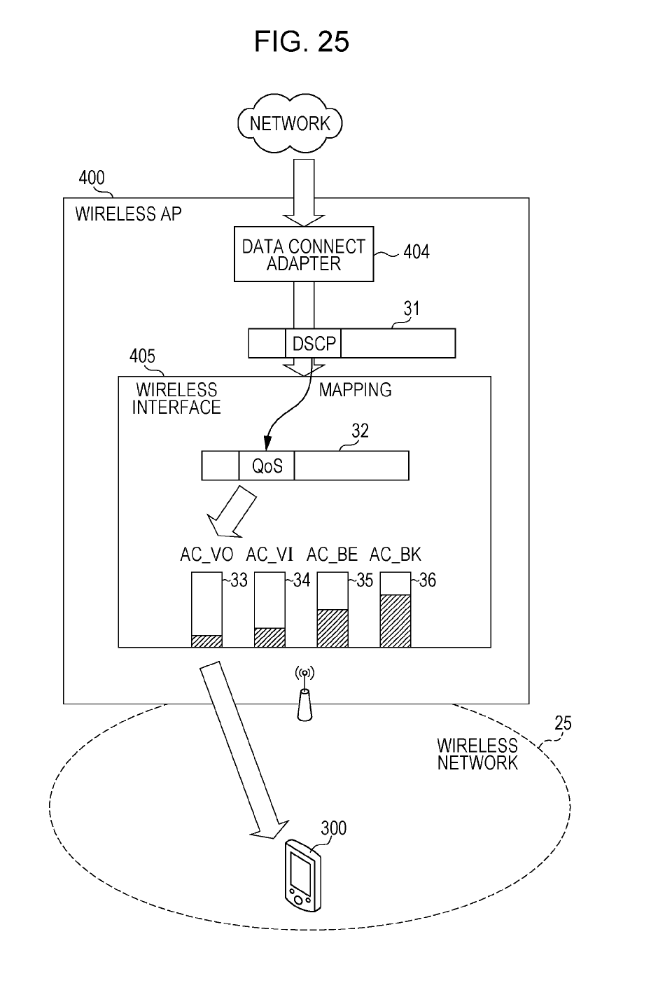

FIG. 25 illustrates an example of mapping of a value indicating a priority. For example, the data connect adapter 404 sets a DSCP value corresponding to the user ID in the DSCP field of a received IP packet 31. Thereafter, the data connect adapter 404 forwards the IP packet 31 to the wireless interface 405. The wireless interface 405 maps the first three bits of the DSCP value to the QoS field of a wireless commination frame 32.

The wireless commination frame 32 is queued in one of send queues 33 to 36 each corresponding to one of the ACs. For example, if the value set by mapping indicates the AC “AC_VO”, the wireless commination frame 32 is queued in the send queue 33 for “AC_VO”.

Data in each of the send queues 33 to 36 is sent after the wait time corresponding to the priority has elapsed using EDCA. The data queued in the send queue 33 for “AC_VO” is transmitted after the shortest wait time has elapsed. As a result, the wireless commination frame 32 to be sent is sent to the terminal device 300 without any delay.

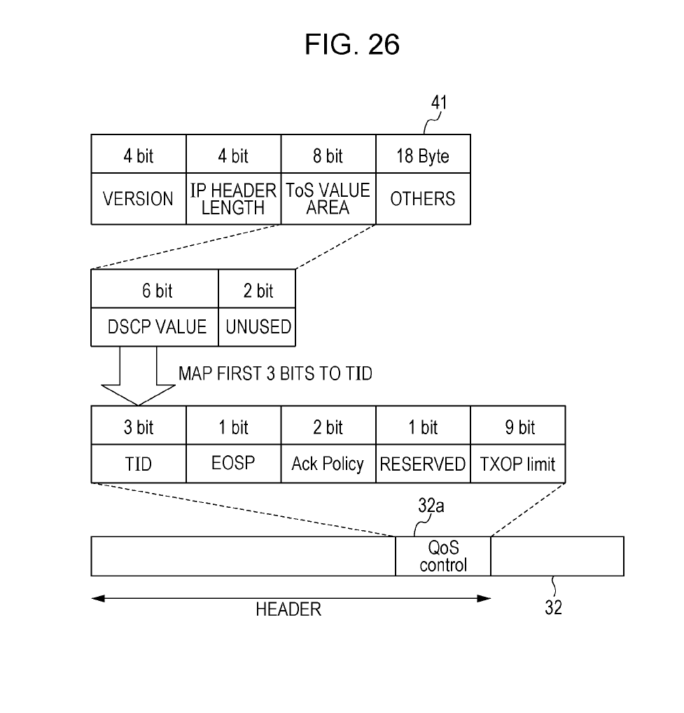

FIG. 26 illustrates the priority mapping process in detail. The header of an IP packet (an IP header 41) has a version field and an IP header length field followed by a 8-bit ToS (Type of Service) value field. The ToS value field is eight bits in length. The upper six bits indicate a DSCP value, and the lower two bits are unused.

In contrast, the header of the wireless commination frame 32 has a QoS control field 32a. The first three bits of the QoS control field 32a represents a TID (Traffic Identifiers) region. The TID is used for specifying the AC. Accordingly, by mapping the first three bits of the DSCP value in the IP header 41 to the first three bits of the QoS control field 32a of the wireless commination frame 32, the priority can be sent.

In this manner, communication between the terminal devices 300 and 800 can be performed using the same quality control policies. In addition, since a target of the priority control is specified by using a user ID, the priority control of communication for each of the users can be facilitated. Furthermore, by sending a packet containing the user ID of the terminal device 300 serving as the connection source from the terminal device 800 serving as the connection destination, data can be received with a quality of the level of the agreement when a user who has signed the agreement receives data.

While the disclosure has been described with reference to the exemplary embodiments above, the configuration of each of the units of the exemplary embodiments may be replaced with a different configuration having the same functionality. In addition, any two or more configurations (features) of the above-described exemplary embodiments may be combined.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A priority control method for use in a server comprising:
upon receiving a priority control request related to communication between a first terminal device connected to a first wireless network and a second terminal device connected to a second wireless network, determining a priority for the communication; and
controlling the communicating between the first terminal devise and the second terminal device for relaying according to the determined priority by performing by the server, a settings on a first wireless base station in the first wireless network to which the first terminal device is connected, a setting on a second wireless base station in the second wireless network to which the second terminal device is connected, and a setting on at least one relaying apparatus that relays communication in a communication path between the first wireless base station and the second wireless base station, thereby communication between the first terminal device and the second terminal device is relayed with the determined priority.

2. The method according to claim 1,
wherein the priority control request includes a user ID for the first terminal device, and
the determining involves referring to a priority associated with the user ID and setting a priority of the communication between the first terminal device and the second terminal device to the priority corresponding to the user ID contained in the priority control request.

3. The method according to claim 2,
wherein the priority is settable based on a service level corresponding to a priority control agreement term for a user.

4. The method according to claim 2,
wherein the performing of settings involves sending a pair of information of the user ID contained in the priority control request and the determined priority to the first wireless base station, the second wireless base station, and the at least one relaying apparatus.

5. The method according to claim 4,
wherein the performing of settings involves sending a pair of information of a user ID and a priority used in the wired network to the first wireless base station, the second wireless base station, and the at least one relaying apparatus,
the method further comprising:
forwarding, from the at least one relaying apparatus, a packet corresponding to the user ID with a quality in accordance with the priority for the wired network;
when the first wireless base station sends the packet corresponding to the user ID to the first terminal device, converting the priority for the wired network received from the server into a priority used in the first wireless network and sending the packet to the first terminal device via the first wireless network with a quality in accordance with the converted priority; and
when the second wireless base station sends the packet corresponding to the user ID to the second terminal device, converting the priority for the wired network received from the server into a priority used in the second wireless network and sending the packet to the second terminal device via the second wireless network with a quality in accordance with the converted priority.

6. The method according to one of claim 1,
wherein the performing of settings involves performing a settings on the first terminal device or on the second terminal device so that the first terminal device or the second terminal device sends responsive data according to the determined priority.

7. The method according to claim 6,
wherein the priority control request contains a user ID for the first terminal device,
wherein the determining involves referring to a priority associated with the user ID and setting a priority of communication between the first terminal device and the second terminal device to the priority corresponding to the user ID contained in the priority control request, and
wherein the performing of settings involves sending an information pair of the user ID and the determined priority to the second terminal device,
the method further comprising:
setting, by the second terminal device, the user ID in a packet destined for the first terminal device; and
sending, from the second terminal device, the packet to the second wireless base station via the second wireless network with a quality in accordance with the determined priority.

8. A server comprising:
Computing hardware to;
upon receiving a priority control request related to communication between a first terminal device connected to a first wireless network and a second terminal device connected to a second wireless network, determine a priority for the communication; and
control the communicating between the first terminal device and the second terminal device for relaying according to the determined priority by a settings on a first wireless base station in the first wireless network to which the first terminal device is connected, a setting on a second wireless base station in the second wireless network to which the second terminal device is connected, and a setting on at least one relaying apparatus that relays communication in a communication path between the first wireless base station and the second wireless base station, thereby communication between the first terminal device and the second terminal device is relayed with the determined priority.

9. A computer-readable recording medium having stored therein a program for causing a computer to execute a process of, upon receiving a priority control request related to communication between a first terminal device connected to a first wireless network and a second terminal device connected to a second wireless network, the process comprising;
determining a priority for the communication; and
performing settings on a first wireless base station in the first wireless network to which the first terminal device is connected, a second wireless base station in the second wireless network to which the second terminal device is connected, and at least one relaying apparatus that relays communication in a communication path between the first wireless base station and the second wireless base station so that communication between the first terminal device and the second terminal device is relayed with the determined priority.
